(19) United States
(12) Patent Application Publication
(10) Pub. No.: US 2016/0117989 A1
(43) Pub. Date: Apr. 28, 2016

(54) DISPLAY APPARATUS, PIXEL CIRCUIT, AND CONTROL METHOD OF DISPLAY APPARATUS

(71) Applicant: SAMSUNG DISPLAY CO., LTD., Yongin-si (JP)

(72) Inventors: Masayuki Kumeta, Yokohama (JP); Ryo Ishii, Yokohama (JP); Seiki Takahashi, Yokohama (JP)

(21) Appl. No.: 14/919,628

(22) Filed: Oct. 21, 2015

(30) Foreign Application Priority Data
Oct. 23, 2014 (JP) 2014-216641
Oct. 23, 2014 (JP) 2014-216646

(51) Int. Cl. G09G 3/32; G09G 3/20

(52) U.S. Cl. CPC G09G 3/3258; G09G 3/3291; G09G 3/2092; G09G 2300/043; G09G 2300/0426

(57) ABSTRACT

A display apparatus includes a display unit including a plurality of pixel circuits, each of the pixel circuits includes: a light emitting device; a driving transistor; a display data updating circuit including a display data capacitor; a threshold voltage compensation circuit including a threshold voltage capacitor; and a switch transistor connected to the display data capacitor and the threshold voltage capacitor. The display data capacitor is electrically disconnected from the threshold voltage capacitor when updating of display data and compensation of a threshold voltage of the driving transistor are performed, and the display data capacitor is electrically connected to the threshold voltage capacitor when the light emitting device emits light.

### CROSS-REFERENCE TO RELATED APPLICATIONS

This U.S. non-provisional patent application claims, under 35 U.S.C. §119, priority to and the benefit of Japanese Patent Application Nos. 2014-216641, filed on Oct. 23, 2014, and 2014-216646, filed on Oct. 23, 2014, the entire contents of both of which are hereby incorporated by reference.

### BACKGROUND

1. Field

One or more example embodiments of the present disclosure herein relate to a display apparatus, a pixel circuit, and a control method of the display apparatus.

2. Description of the Related Art

Each pixel circuit of an active matrix type display apparatus including an organic electro luminescence element (organic EL element) includes a light emitting device and a driving transistor that controls current flowing to the light emitting device.

The current flowing to the light emitting device may vary for each pixel circuit according to a variation of the properties or characteristics of the driving transistor of each of the pixel circuits. The variation of the properties or characteristics of the driving transistor may occur due to a variation in threshold voltage (hereinafter, referred to as a “VTH” or “threshold voltage”) of the driving transistor. If the current flowing to the light emitting devices of the pixel circuits are not the same, but are different from each other, luminance may be non-uniform and image quality may degrade.

Technology for compensating the threshold voltage of the driving transistor of the pixel circuit has been developed. Also, technology for performing VTH compensation and updating of display data in 1 horizontal period 1H and technology for increasing a VTH compensation time have been developed.

For example, threshold voltage is detected by using first and second capacitors. Thereafter, the display data is updated through capacitive coupling of the first and second capacitors. Also, the VTH compensation and display data updating are performed during the 1 horizontal period 1H.

However, since the more the resolution increases, the more the 1 horizontal period decreases, and a time taken to perform the VTH compensation may be decreased. Thus, the more the resolution increases, the more the VTH compensation performance may decrease. Further, if the VTH compensation performance decreases, the threshold voltage may not be sufficiently (or effectively) compensated. Thus, the current flowing to the light emitting device of each of the pixel circuits may change (e.g., be different), which may cause image quality degradation due to the non-uniform luminance.

Further, the VTH compensation may be performed for a plurality of lines at the same time, and capacitance of a capacitor provided in each pixel circuit may vary. Thus, the VTH compensation time may increase. Also, the image quality degradation due to a variation in source voltage of the transistor, which may occur by leakage current, may be restrained during a standby time from a VTH compensation ending time to an image signal input time.

However, a structure of a pixel changes for each pixel circuit to cause a variation in capacitance. Since the variations in capacitance due to the variation of the leakage current and the change of the pixel structure are not interlocked with each other, the image quality degradation due to the two property changes may increase.

The above information disclosed in this Background section is only for enhancement of understanding of the background of the inventive concept, and therefore, it may contain information that does not constitute prior art.

### SUMMARY

Aspects of one or more embodiments of the inventive concept are directed toward a display apparatus that is capable of improving threshold voltage compensation (VTH compensation) performance, a pixel circuit capable of the same, and a control method of the display apparatus.

According to an embodiment, a display apparatus includes: a display unit configured to receive display data to display an image, the display unit including a plurality of pixel circuits arranged in a matrix form, wherein each of the pixel circuits includes: a light emitting device configured to receive current to emit light; a driving transistor configured to control the current flowing through the light emitting device; a display data updating circuit including a display data capacitor configured to maintain the display data, the display data updating circuit being configured to update the display data that is maintained by the display data capacitor; a threshold voltage compensation circuit including a threshold voltage capacitor configured to maintain a threshold voltage of the driving transistor, the threshold voltage compensation circuit being configured to detect the threshold voltage of the driving transistor and to compensate the threshold voltage; and a first switch transistor connected to the display data capacitor and the threshold voltage capacitor, wherein the display data capacitor and the threshold voltage capacitor are configured to be electrically disconnected from each other, when the updating of the display data and the compensation of the threshold voltage of the driving transistor are performed, and wherein the display data capacitor and the threshold voltage capacitor are configured to be electrically connected to each other, when the light emitting device emits light.

In an embodiment, the display data updating circuit may be configured to update the display data when the threshold voltage is maintained in the threshold voltage capacitor.

In an embodiment, the threshold voltage compensation circuit may be configured to compensate the threshold voltage of the driving transistor when the display data is maintained in the display data capacitor.

In an embodiment, the display data updating circuit may further include a second switch transistor configured to control updating timing of the display data, and the second switch transistor may be configured to connect a first electrode of the display data capacitor to a data line to which the display data is supplied according to a control signal to update the display data.

In an embodiment, the threshold voltage compensation circuit may further include: a diode-connecting transistor connected to a first electrode of the threshold voltage capacitor and configured to diode-connect the driving transistor to detect the threshold voltage of the driving transistor; an initialization transistor configured to initialize a voltage that is maintained in the threshold voltage capacitor; and a third switch transistor configured to connect a second electrode of the threshold voltage capacitor to a first electrode of the driving transistor when the detection of the threshold voltage of the driving transistor is performed, the first electrode of the driving transistor being opposite to a second electrode of the driving transistor that is connected to the light emitting device, wherein the threshold voltage of the driving transistor may be detected and compensated according to a control signal for detecting and compensating the threshold voltage of the driving transistor.

In an embodiment, the updating of the display data by the display data updating circuit and the compensation of the threshold voltage of the driving transistor by the threshold voltage compensation circuit may be performed concurrently.

In an embodiment, the display data updating circuit further may further include a second switch transistor configured to control updating timing of the display data, and the second switch transistor may be configured to connect a first electrode of the display data capacitor to a data line to which the display data is supplied to update the display data according to a same control signal as the control signal supplied to the threshold voltage compensation circuit to detect and compensate the threshold voltage of the driving transistor.

In an embodiment, the threshold voltage compensation circuit may include: a diode-connecting transistor connected to a first electrode of the threshold voltage capacitor and configured to diode-connect the driving transistor to detect the threshold voltage of the driving transistor; an initialization transistor configured to initialize a voltage that is maintained in the threshold voltage capacitor; and a third switch transistor configured to connect a second electrode of the threshold voltage capacitor to a first electrode of the driving transistor when the detection of the threshold voltage of the driving transistor is performed, the first electrode of the driving transistor being opposite to a second electrode of the driving transistor that is connected to the light emitting device, wherein the threshold voltage of the driving transistor may be detected and compensated according to a same control signal supplied to the display data updating circuit to perform the updating of the display data.

In an embodiment, the display apparatus may further include a controller configured to control the updating of the display data and the compensation of the threshold voltage of the driving transistor.

In an embodiment, the updating of the display data and the compensation of the threshold voltage of the driving transistor may be line-successively performed.

In an embodiment, the compensation of the threshold voltage of the driving transistor may be performed during a plurality of horizontal periods.

In an embodiment, the display data updating circuit may be configured to update the display data when the threshold voltage is maintained in the threshold voltage capacitor, the threshold voltage compensation circuit may be configured to compensate the threshold voltage of the driving transistor when the display data is maintained in the display data capacitor, and the threshold voltage compensation of the driving transistor may be performed concurrently for the plurality of pixel circuits, and the updating of the display data may be line-successively performed for the plurality of pixel circuits.

In an embodiment, the threshold voltage compensation of the driving transistor by the threshold voltage compensation circuit may be performed several times during 1 vertical period.

In an embodiment, control signals for detecting and compensating the threshold voltage of the driving transistor may be supplied a plurality of times to the threshold voltage compensation circuit, and the threshold voltage compensation circuit may be configured to detect and to compensate the threshold voltage of the driving transistor according to the control signals.

In an embodiment, control signals for controlling the updating of the display data, the threshold voltage compensation of the driving transistor, and the light emission of the light emitting device may be supplied to odd-numbered lines of the pixel circuits from a first driver corresponding to a first sub frame, and control signals for controlling the updating of the display data, the threshold voltage compensation of the driving transistor, and the light emission of the light emitting device may be supplied to even-numbered lines of the pixel circuits from a second driver corresponding to a second sub frame.

In an embodiment, control signals for controlling the updating of the display data, the threshold voltage compensation of the driving transistor, and the light emission of the light emitting device may be supplied to odd-numbered pixel circuits of odd-numbered rows of the pixel circuits and to even-numbered pixel circuits of even-numbered rows of the pixel circuits from a first driver corresponding to a first sub frame, and control signals for controlling the updating of the display data, the threshold voltage compensation of the driving transistor, and the light emission of the light emitting device may be supplied to even-numbered pixel circuits of the odd-numbered rows and to odd-numbered pixel circuits of the even-numbered rows from a second driver corresponding to a second sub frame.

In an embodiment, the display data updating circuit may further include a second switch transistor configured to control updating timing of the display data, and the second switch transistor may be configured to connect a first electrode of the display data capacitor to a data line to which the display data is supplied according to a control signal to update the display data.

In an embodiment, the threshold voltage compensation circuit may further include: a diode-connecting transistor connected to a first electrode of the threshold voltage capacitor and configured to diode-connect the driving transistor to detect the threshold voltage of the driving transistor; an initialization transistor configured to initialize a voltage that is maintained in the threshold voltage capacitor; and a third switch transistor configured to connect a second electrode of the threshold voltage capacitor to a first electrode of the driving transistor when the detection of the threshold voltage of the driving transistor is performed, the first electrode of the driving transistor being opposite to a second electrode of the driving transistor that is connected to the light emitting device, wherein the threshold voltage of the driving transistor may be detected and compensated according to a control signal for detecting and compensating the threshold voltage of the driving transistor.

According to an embodiment, a pixel circuit includes: a light emitting device configured to receive current to emit light; a driving transistor configured to control the current flowing through the light emitting device; a display data updating circuit including a display data capacitor configured to maintain the display data, the display data updating circuit being configured to update the display data that is maintained by the display data capacitor; a threshold voltage compensation circuit including a threshold voltage capacitor configured to maintain a threshold voltage of the driving transistor, the threshold voltage compensation circuit being configured to detect the threshold voltage of the driving transistor and to compensate the threshold voltage; and a switch transistor connected to the display data capacitor and the threshold voltage capacitor, wherein the display data capacitor and the threshold voltage capacitor are electrically disconnected from each other, when the updating of the display data and the compensation of the threshold voltage of the driving transistor are performed, and wherein the display data capacitor and the threshold voltage capacitor are electrically connected to each other, when the light emitting device emits light.

According to an embodiment, a method for controlling a display apparatus including: a display unit configured to receive display data to display an image, the display unit including a plurality of pixel circuits arranged in a matrix form, wherein each of the pixel circuits includes: a light emitting device configured to receive current to emit light; a driving transistor configured to control the current flowing through the light emitting device; a display data updating circuit comprising a display data capacitor configured to maintain the display data, the display data updating circuit being configured to update the display data that is maintained by the display data capacitor; a threshold voltage compensation circuit including a threshold voltage capacitor configured to maintain a threshold voltage of the driving transistor, the threshold voltage compensation circuit being configured to detect the threshold voltage of the driving transistor and to compensate the threshold voltage; and a first switch transistor connected to the display data capacitor and the threshold voltage capacitor, the method includes: controlling updating of the display data, compensation of the threshold voltage of the driving transistor, and light emission of the light emitting device in each of the pixel circuits, wherein the controlling includes: disconnecting the display data capacitor from the threshold voltage capacitor, when the updating of the display data and the compensation of the threshold voltage of the driving transistor are performed; and electrically connecting the display data capacitor to the threshold voltage capacitor, when the light emitting device emits light.

### BRIEF DESCRIPTION OF THE DRAWINGS

The accompanying drawings are included to provide a further understanding of the inventive concept, and are incorporated in and constitute a part of this specification. The drawings illustrate exemplary embodiments of the inventive concept and, together with the description, serve to explain aspects and features of the inventive concept. In the drawings:

FIG. 1 is a view of a pixel circuit according to an embodiment of the inventive concept;

FIG. 2 is a timing chart illustrating an operation of a display apparatus according to an embodiment of the inventive concept;

FIG. 3 is a view of a display apparatus according to a first embodiment of the inventive concept;

FIG. 4 is a timing diagram illustrating an operation of the display apparatus during 1 vertical period according to the first embodiment of the inventive concept;

FIG. 5 is a view of a pixel circuit according to the first embodiment of the inventive concept;

FIG. 6 is a timing graph illustrating the supply of control signals according to the first embodiment of the inventive concept;

FIGS. 7A to 7D are views illustrating an operation of the pixel circuit according to the first embodiment of the inventive concept;

FIG. 8 is a view of a display apparatus according to a second embodiment of the inventive concept;

FIG. 9 is a timing diagram illustrating an operation of a display apparatus during 1 vertical period according to the second embodiment of the inventive concept;

FIG. 10 is a view of a pixel circuit according to the second embodiment of the inventive concept;

FIG. 11 is a timing graph illustrating the supply of control signals according to the second embodiment of the inventive concept;

FIGS. 12A to 12C are views illustrating an operation of the pixel circuit according to the second embodiment of the inventive concept;

FIG. 13 is a timing chart illustrating an operation of a display apparatus according to a third embodiment of the inventive concept;

FIG. 14 is a view of the display apparatus according to the third embodiment of the inventive concept;

FIG. 15 is a timing diagram illustrating the operation of the display apparatus during 1 vertical period according to the third embodiment of the inventive concept;

FIG. 16 is a view of a pixel circuit according to the third embodiment of the inventive concept;

FIG. 17 is a timing graph illustrating the supply of control signals according to the third embodiment of the inventive concept;

FIGS. 18A to 18D are views illustrating an operation of the pixel circuit according to the third embodiment of the inventive concept;

FIG. 19 is a timing chart illustrating an operation of a display apparatus according to a fourth embodiment of the inventive concept;

FIG. 20 is a view of the display apparatus according to the fourth embodiment of the inventive concept;

FIG. 21 is a timing diagram illustrating an operation of the display apparatus during 1 vertical period according to the fourth embodiment of the inventive concept; and

FIG. 22 is a view of a display apparatus according to a fifth embodiment of the inventive concept.

### DETAILED DESCRIPTION

Aspects and features of the inventive concept, and implementation methods thereof, will be described in more detail with reference to the following embodiments described with reference to the accompanying drawings. The inventive concept may, however, be embodied in various different forms, and should not be construed as being limited to the embodiments set forth herein. Rather, these embodiments are provided so that this disclosure will be thorough and complete, and will fully convey the spirit and scope of the inventive concept to those skilled in the art. Further, the inventive concept is only defined by the scope of claims, and their equivalents. Like reference numerals refer to like elements throughout.

In the drawings, the relative sizes of elements, layers, and regions may be exaggerated for clarity. Spatially relative terms, such as “beneath,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the inventive concept.

It will be understood that when an element or layer is referred to as being “on,” “connected to,” or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments only and is not intended to be limiting of the inventive concept. As used herein, the singular forms “a” and “an” are intended to include the plural forms as well, unless the context clearly indicates otherwise. It will be further understood that the terms “comprises,” “comprising,” “includes,” and “including,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list.

As used herein, the term “substantially,” “about,” and similar terms are used as terms of approximation and not as terms of degree, and are intended to account for the inherent variations in measured or calculated values that would be recognized by those of ordinary skill in the art. Further, the use of “may” when describing embodiments of the present invention refers to “one or more embodiments of the present invention.” As used herein, the terms “use,” “using,” and “used” may be considered synonymous with the terms “utilize,” “utilizing,” and “utilized,” respectively. Also, the term “exemplary” is intended to refer to an example or illustration.

The embodiments described in the detailed description will be described with reference to schematic cross-sectional views and/or plan views as exemplary views of the inventive concept. Accordingly, shapes of the exemplary views may be modified according to manufacturing techniques and/or allowable errors. Therefore, the inventive concept is not limited to the specific shape illustrated in the exemplary views, but may include other shapes that may be created according to manufacturing processes. Areas exemplified in the drawings have general properties, and are used to illustrate a specific shape of a semiconductor package region. Thus, this should not be construed as limiting the scope of the inventive concept.

The electronic or electric devices and/or any other relevant devices or components according to embodiments of the inventive concept described herein may be implemented utilizing any suitable hardware, firmware (e.g. an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the exemplary embodiments of the inventive concept.

Unless otherwise defined, all terms (including technical and scientific terms) used herein have the same meaning as commonly understood by one of ordinary skill in the art to which the present inventive concept belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

A display apparatus according to one or more embodiments of the inventive concept may be an active matrix type display apparatus including a plurality of pixel circuits, each of which includes a light emitting device and a driving transistor.

Here, the light emitting device may be any suitable light emitting device that receives current to emit light, for example, such as an organic electro-luminescence element (organic EL element), or an inorganic electro-luminescence element (inorganic EL element). Hereinafter, for convenience of description, the organic EL element may be described as the light emitting device according to one or more embodiments of the inventive concept.

As described above, the more the resolution increases, the more a VTH compensation time decreases, and the more the VTH compensation performance may be deteriorated.

In one or more embodiments of the inventive concept, each of the pixel circuits includes a display data updating circuit and a threshold voltage compensation circuit (hereinafter, referred to as a “VTH compensation circuit). The display data updating circuit and the VTH compensation circuit are connected to a circuit disconnection switch. The circuit disconnection switch may selectively connect and/or disconnect the display data updating circuit to or from the VTH compensation circuit. Since the display data updating circuit and the VTH compensation circuit are selectively connected or disconnected by the circuit disconnection switch, an updating operation for display data and a VTH compensation operation may be individually controlled. In one or more embodiments of the inventive concept, the updating operation for the display data, the VTH compensation operation, and a light emitting operation of the light emitting device may be performed by a control unit (e.g., a controller) arranged in the display apparatus, or by an external control device having at least the same or substantially the same function as that of the control unit.

Since the updating operation for the display data and the VTH compensation operation are individually performed by the display data updating circuit and the VTH compensation circuit, respectively, the display apparatus according to one or more embodiments of the inventive concept may increase the VTH compensation time. For example, since the VTH compensation operation is performed during a plurality of horizontal periods, the VTH compensation time may increase. Thus, the display apparatus according to one or more embodiments of the inventive concept may improve the VTH compensation performance.

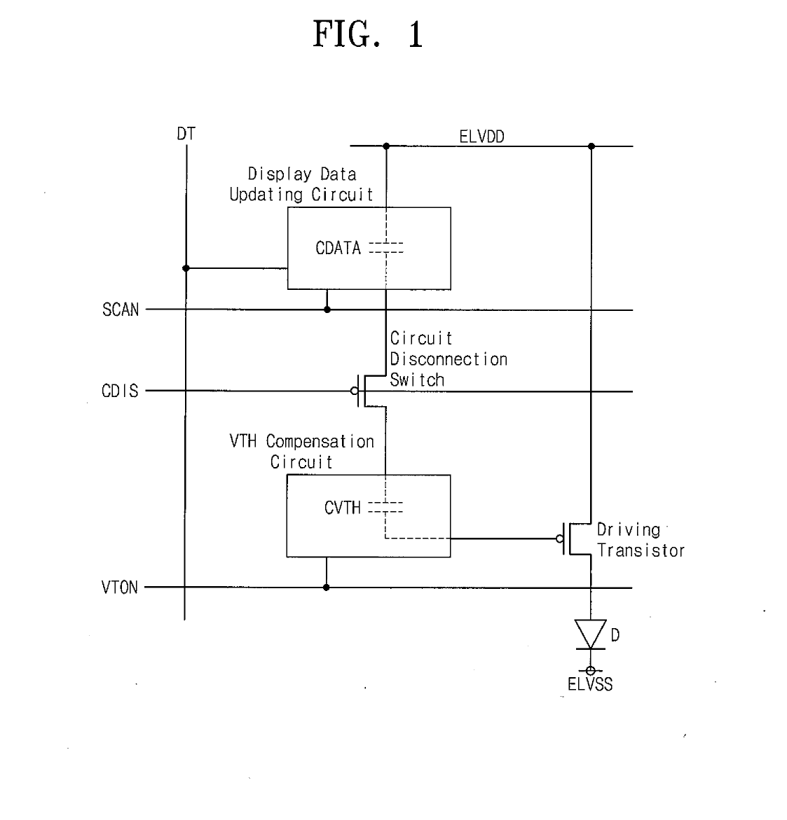

FIG. 1 is a view of a pixel circuit according to an embodiment of the inventive concept.

A pixel circuit according to an embodiment of the inventive concept includes a light emitting device D, a driving transistor, a display data updating circuit, a VTH compensation circuit (threshold voltage compensation circuit), and a circuit disconnection switch.

The driving transistor controls current flowing to the light emitting device D. The driving transistor is connected to an anode electrode of the light emitting device D. The driving transistor may supply current to the anode electrode of the light emitting device D according to display data.

The driving transistor may be a field-effect transistor (FET), such as a thin film transistor (TFT). The driving transistor illustrated in FIG. 1 is not limited to a P-channel type TFT. For example, in some embodiments, the driving transistor may be an N-channel type TFT.

Hereinafter, the transistors included in the pixel circuits may be the P-channel type TFT, but the inventive concept is not limited thereto. For example, the N-channel type TFT may be used as the transistors included in the pixel circuits. Alternatively, in some embodiments, the P-channel type TFT may be used as some of the transistors and the N-channel type TFT may be used as some of the transistors included in the pixel circuits.

The driving transistor includes a first electrode connected to the anode electrode the light emitting device D, a second electrode connected to a first power source ELVDD, and a gate electrode. The driving transistor connects the first power source ELVDD connected to the second electrode of the driving transistor to the anode electrode of the light emitting device D connected to the first electrode of the driving transistor when a voltage is applied to the gate electrode of the driving transistor. As a result, light may be selectively emitted from the light emitting device D by the driving transistor. For example, the first electrode of the driving transistor may be a drain electrode, and the second electrode of the driving transistor may be a source electrode.

The display data updating circuit includes a display data capacitor CDATA that is capable of maintaining (or charging) or substantially maintaining the display data. The display data updating circuit updates the display data that is maintained or substantially maintained in the display data capacitor CDATA. The display data capacitor CDATA may be a capacitor having a capacitance (e.g., a predetermined capacitance). Also, the display data capacitor may be a parasitic capacitor. The display data updating circuit will be described below in more detail.

The VTH compensation circuit includes a threshold voltage capacitor CVTH that is capable of maintaining (or charging) or substantially maintaining a threshold voltage of the driving transistor. The VTH compensation circuit detects the threshold voltage of the driving transistor to compensate for the threshold voltage. The threshold voltage capacitor CVTH may be a capacitor having a capacitance (e.g., a predetermined capacitance). Also, the threshold voltage maintenance capacitance may be a parasitic capacitance. The VTH compensation circuit will be described below in more detail.

The circuit disconnection switch includes a switch transistor (or a first switch transistor). The switch transistor of the circuit disconnection switch is connected to the display data capacitor CDATA and the threshold voltage capacitor CVTH.

The switch transistor of the circuit disconnection switch is turned on/off according to a control signal that is applied to the gate electrode of the switch transistor of the circuit disconnection switch through a control line CDIS. Thus, the switch transistor of the circuit disconnection switch may electrically connect or disconnect the display data updating circuit to and/or from the VTH compensation circuit.

For example, when the updating operation for the display data is performed, and the compensation operation for the threshold voltage of the driving transistor is performed, the display data capacitor CDATA and the threshold voltage capacitor CVTH are electrically disconnected from each other. When the light emitting device emits light, the display data capacitor CDATA and the threshold voltage capacitor CVTH may be electrically connected to each other.

In an embodiment of the inventive concept, the display data capacitor CDATA and the threshold voltage capacitor CVTH of the pixel circuit may be electrically disconnected from each other. Thus, the display apparatus according to an embodiment of the inventive concept, the operation for performing the updating of the display data may be performed in a state in which the threshold voltage capacitor CVTH is maintained or substantially maintained at a threshold voltage, and the VTH compensation operation may be performed in a state in which the display data capacitor CDATA is maintained or substantially maintained with the display data.

The display apparatus according to an embodiment of the inventive concept may control the updating of the display data and the VTH compensation at an individual timing to increase the VTH compensation time, regardless of the horizontal period. Since the VTH compensation time increases regardless of the horizontal period, although the horizontal period decreases due to the increase of the resolution, an occurrence of image quality degradation due to the leakage of the VTH compensation time may be prevented or substantially prevented. Also, in the display apparatus according to an embodiment of the inventive concept, since the updating of the display data and the VTH compensation are individually controlled, the VTH compensation may be performed several times during the 1 vertical period. Since the VTH compensation is performed several times during the 1 vertical period, the threshold voltage capacitor CVTH of the VTH compensation circuit of each of the pixel circuits may decrease in size. Thus, the display apparatus according to an embodiment of the inventive concept may realize high precision.

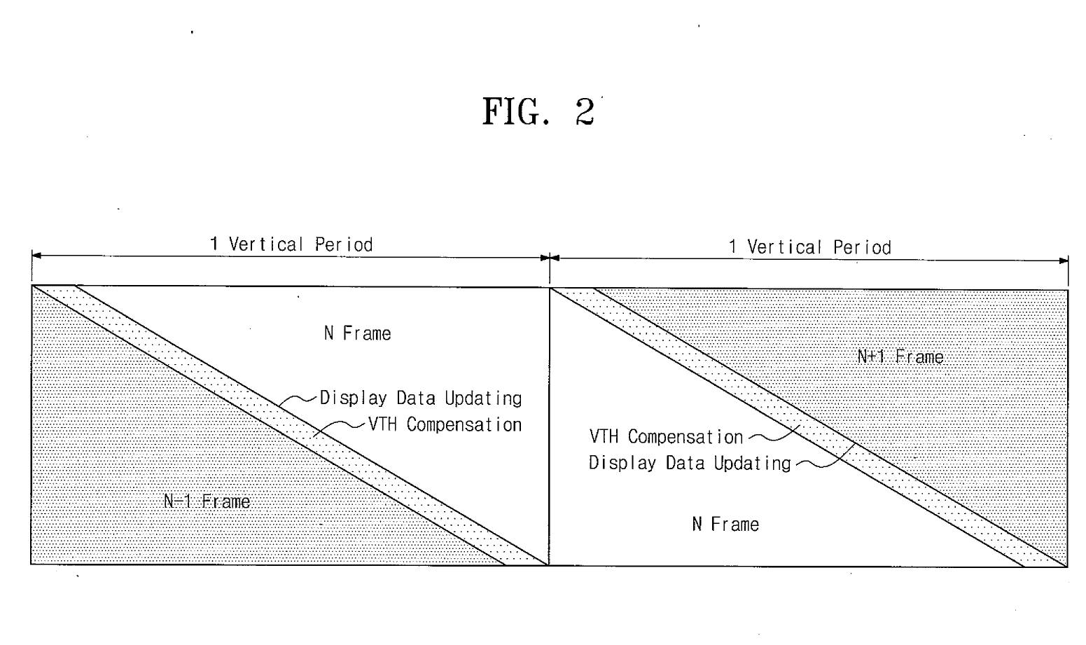

FIG. 2 is a timing chart illustrating an operation of the display apparatus according to an embodiment of the inventive concept. FIG. 2 illustrates an operation timing view of a display apparatus that will be described below according to first and second embodiments of the inventive concept.

As illustrated in FIG. 2, in a display apparatus according to an embodiment of the inventive concept, VTH compensation and display data updating are performed linearly (e.g., horizontal line unit) in order during a plurality of horizontal periods of each of vertical periods. For example, after the light emission is stopped, (a) VTH compensation during an initial period, (b) VTH compensation during a plurality of horizontal periods, (c) updating of display data, and (d) light emission are performed linearly in order from the process (a) to the process (d).

Hereinafter, the display apparatus according to an embodiment of inventive concept will be described in more detail.

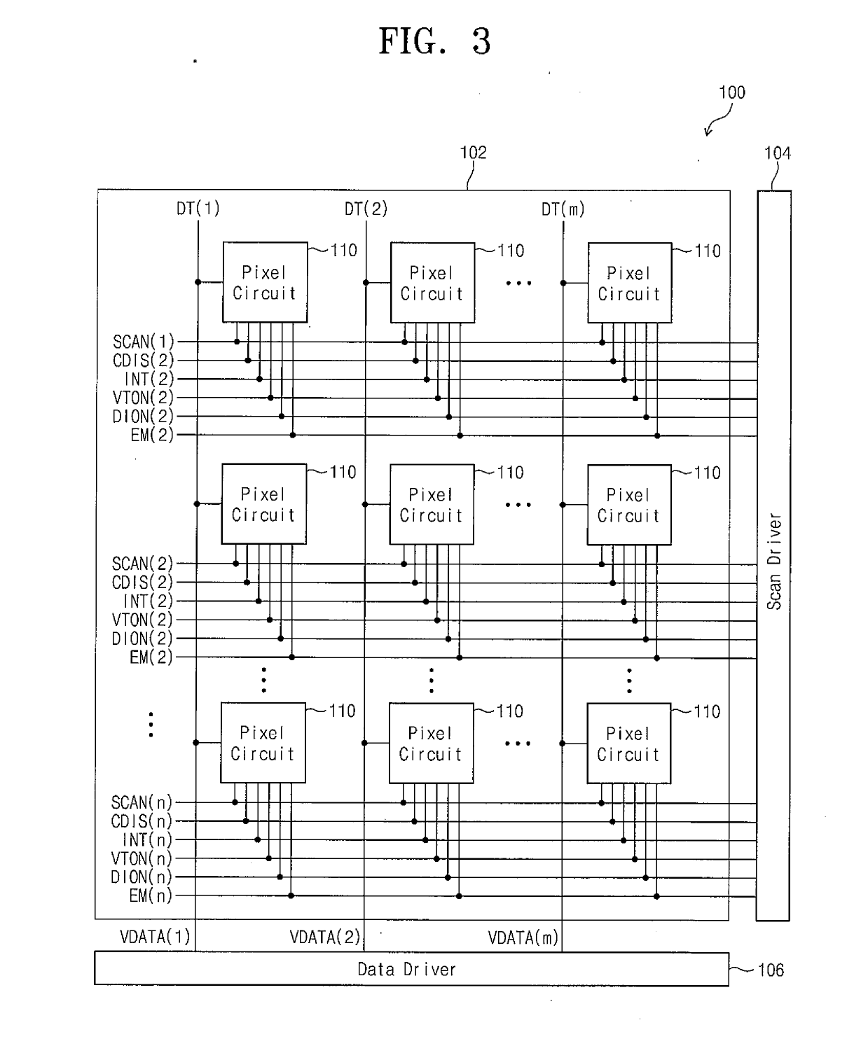

FIG. 3 is a view of the display apparatus according to the first embodiment of the inventive concept.

Referring to FIG. 3, a display apparatus 100 according to the first embodiment of the inventive concept includes a display unit 102, a scan driver 104, and a data driver 106.

The display unit 102 includes a plurality of pixel circuits 110 for displaying an image on the basis of provided display data. The pixel circuits 110 are arranged in a matrix form. The pixel circuits 110 are respectively connected to control lines SCAN, CDIS, INT, VTON, DION, and EM, which extend in a row direction, and signal lines DT that extend in a column direction. The scan driver 104 and the data driver 106 may serve as control units (e.g., controllers) for controlling operations of the pixel circuits 110.

For example, each of the scan driver 104 and the data driver 106 controls an updating operation for display data of the pixel circuits 110, a compensation operation for threshold voltages of driving transistors, and a light emitting operation of light emitting devices D.

Although not shown, the control unit according to an embodiment of the inventive concept includes a timing controller for controlling operation timing of the scan driver 104 and the data driver 106.

Also, as described above, the updating operation for the display data of the pixel circuits 110, the compensation operation for the threshold voltage of the driving transistors, and the light emitting operation of the light emitting devices D may be performed by an external control device (or an external control circuit) having at least the same or substantially the same function as the control unit. In this case, the display apparatus according to the first embodiment may not include the scan driver 104 and the data driver 106, which serve as the control unit. Also, although not shown in FIG. 3, a first voltage ELVDD and a second voltage ELVSS are supplied to the pixel circuits 110 and the data driver 106.

For example, the first voltage ELVDD may be supplied to the pixel circuits 110 and the data driver 106 from a first common power source. The second voltage ELVSS may be supplied to the pixel circuits 110 and the data driver 106 from a second common power source.

The first voltage ELVDD is selectively applied to a first electrode (e.g., anode electrode) of the light emitting device D of each of the pixel circuits 110. The second voltage ELVSS is applied to a second electrode (e.g., cathode electrode) of the light emitting device D of each of the pixel circuits 110.

The first and second common power sources according to an embodiment of the inventive concept may be arranged in the display apparatus 100, or may be external power sources of the display apparatus 100. In some embodiments, the first and second common power sources may be one power source circuit (or power source), or may be power source circuits (or power sources) different from each other.

The scan driver 104 is connected to the control lines SCAN, CDIS, INT, VTON, DION, and EM to selectively provide corresponding control signals to the control lines SCAN, CDIS, INT, VTON, DION, and EM.

A SCAN signal provided to the control line SCAN may be a control signal for controlling updating of the timing of the display data. A CDIS signal provided to the control line CDIS may be a control signal for controlling the switch timing of a circuit disconnection switch that disconnects a display data updating circuit from a VTH compensation circuit.

An INT signal provided to the control line INT may be a control signal for controlling the initialization timing of the pixel circuit 110. Each of a VTON signal provided to the control line VTON and a DION signal provided to the control line DION may be a control signal for controlling VTH compensation timing. An EM signal provided to the control line EM may be a control signal for controlling light emission and non-emission of the light emitting device.

The data driver 106 is connected to the signal lines DT to selectively provide display data VDATA to the signal lines DT.

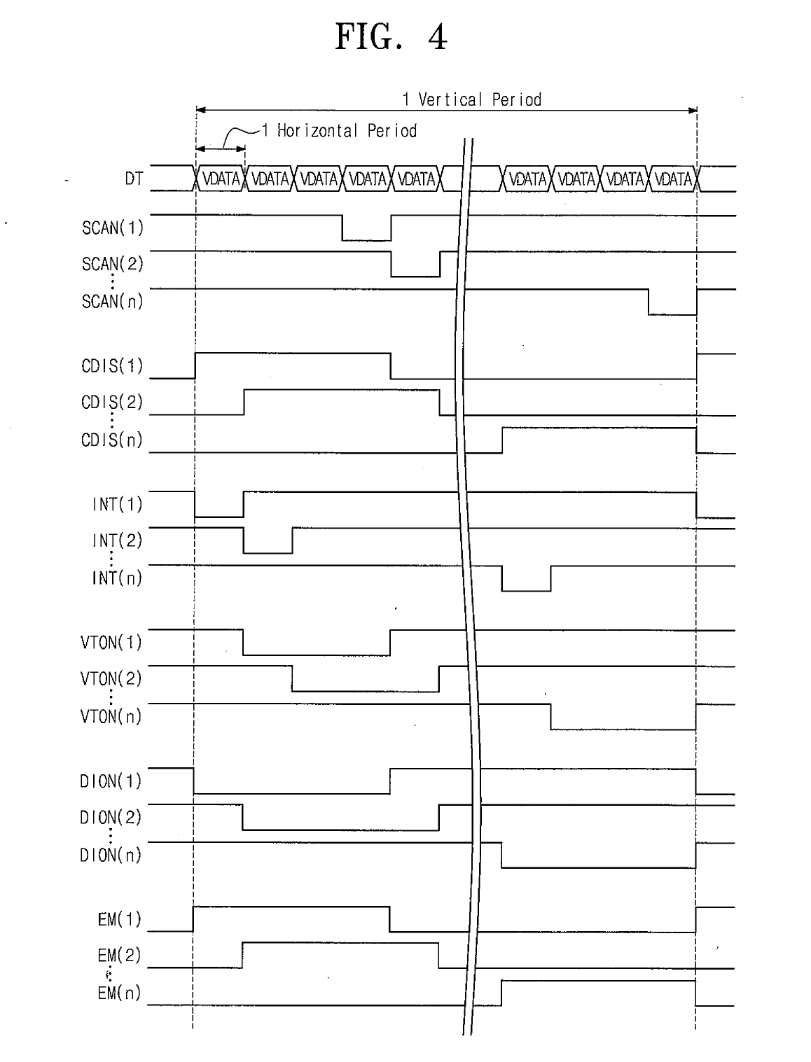

FIG. 4 is a timing diagram illustrating an operation of the display apparatus during 1 vertical period according to the first embodiment of the inventive concept.

Referring to FIG. 4, the VTH compensation and the updating of the display data during the 1 vertical period may be line-successively performed in each pixel circuit 110 by the control signals.

The VTH compensation operation in each pixel circuit 110 may be performed as follows.

In each pixel circuit 110, the light emission may be stopped by the EM signal, and concurrently (e.g., simultaneously), the display data updating circuit and the VTH compensation circuit may be electrically disconnected from each other by the CDIS signal. In a state in which a threshold voltage capacitor CVTH is connected to the source electrode of the driving transistor by the VTON signal, the threshold voltage capacitor CVTH may be initialized by the INT signal. The drain electrode and gate electrode of the driving transistor are diode-connected to each other by the DION signal to perform a VTH compensation operation.

The updating operation for the display data in each pixel circuit 110 may be performed as follows.

In each pixel circuit 110, in a state in which the light emission is stopped by the EM signal, and concurrently (e.g., simultaneously), the display data updating circuit and the VTH compensation circuit are electrically disconnected from each other by the CDIS signal, the updating operation for the display data may be performed by the SCAN signal. This operation will be described together with specific components of the pixel circuit 110 according to some embodiments.

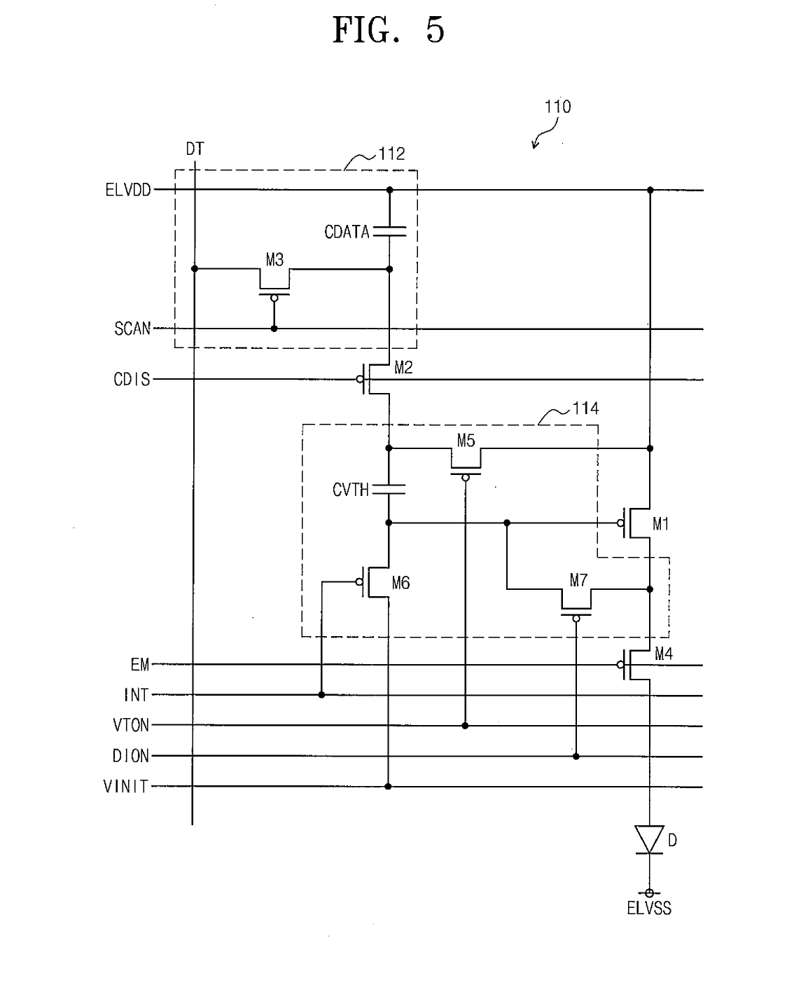

FIG. 5 is a view of the pixel circuit according to the first embodiment of the inventive concept.

Referring to FIG. 5, the pixel circuit 110 includes a light emitting device D, a driving transistor M1, a display data updating circuit 112, a threshold voltage compensation circuit 114, a switching transistor M2 (e.g., a first switch transistor), and a switch transistor M4 for controlling light emission and non-emission of the light emitting device D.

The display data updating circuit 112 and the threshold voltage compensation circuit 114 are connected to the switching transistor M2. The switching transistor M2 is turned on/off by the CDIS signal provided to the gate electrode of the switching transistor M2. The display data updating circuit 112 and the threshold voltage compensation circuit 114 are electrically connected to or disconnected from each other by the on/off operation of the switching transistor M2. The switch transistor M4 may be turned on/off by the EM signal provided to the gate electrode of the switch transistor M4 to control the light emission and non-emission of the light emitting device D.

The display data updating circuit 112 includes a switch transistor M3 (e.g., a second switch transistor) for controlling display data updating timing, and a display data capacitor CDATA.

The switch transistor M3 may be turned on/off according to the control signal SCAN supplied to the gate electrode of the switch transistor M3 to selectively connect a first electrode of the display data capacitor CDATA to a data line DT to which the display data is supplied. A second electrode of the display data capacitor CDATA is connected to the first power source ELVDD.

The threshold voltage compensation circuit 114 includes a threshold voltage capacitor CVTH, a diode transistor (e.g., a diode-connecting transistor) M7, an initialization transistor M6, and a switch transistor M5 (e.g., a third switch transistor).

The diode transistor M7 is connected to the first electrode of the threshold voltage capacitor CVTH. The diode transistor M7 diode-connects the driving transistor M1 to detect a threshold voltage of the driving transistor M1. The diode transistor M7 is turned on/off by the control signal DION supplied to the gate electrode of the diode transistor M7.

The initialization transistor M6 initializes a voltage that is maintained (or charged) or substantially maintained in the threshold voltage capacitor CVTH. The voltage maintained or substantially maintained in the threshold voltage capacitor CVTH may be an initialized voltage to initialize the gate electrode of the driving transistor M1. The initialization transistor M6 is turned on/off by the control signal INT supplied to the gate electrode of the initialization transistor M6.

When the detection of the threshold voltage of the driving transistor M1 is performed, the switch transistor M5 connects the second electrode of the threshold voltage capacitor CVTH to the source electrode (e.g., a first electrode) of the driving transistor M1, the source electrode being opposite to the drain electrode (e.g., a second electrode) connected to the light emitting device D in FIG. 5. The switch transistor M5 is turned on/off by the control signal VTON supplied to the gate electrode of the switch transistor M5.

The pixel circuit 110 is not limited to that illustrated in FIG. 5. For example, the display data updating circuit 112 and the threshold voltage compensation circuit 114 of the pixel circuit 110 may be variously changed into any suitable circuit that is capable of performing the above-described function.

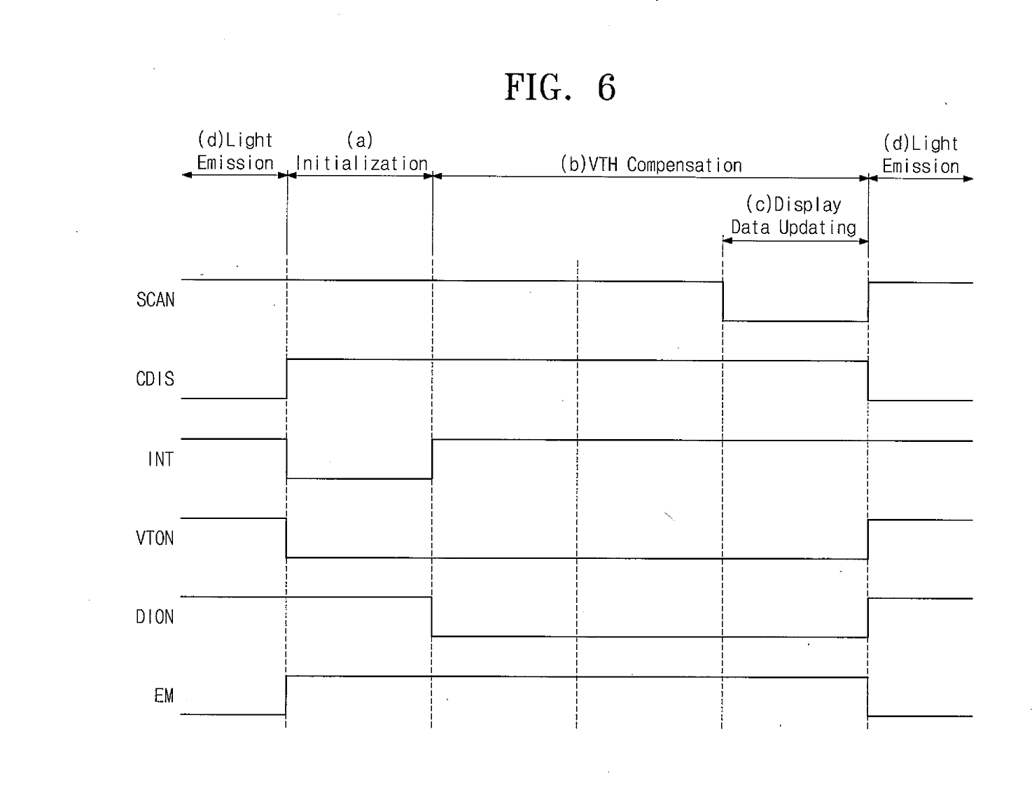

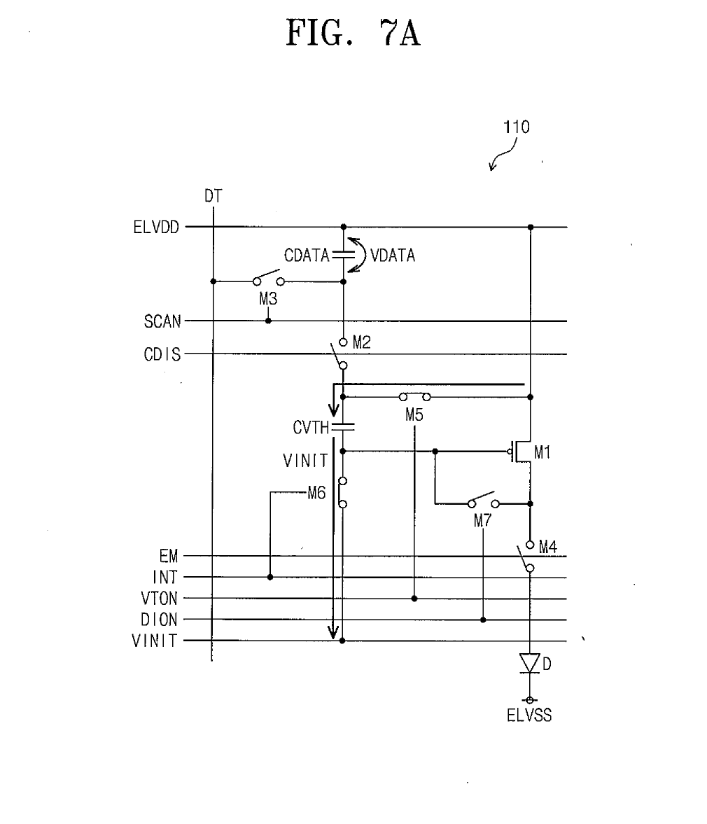

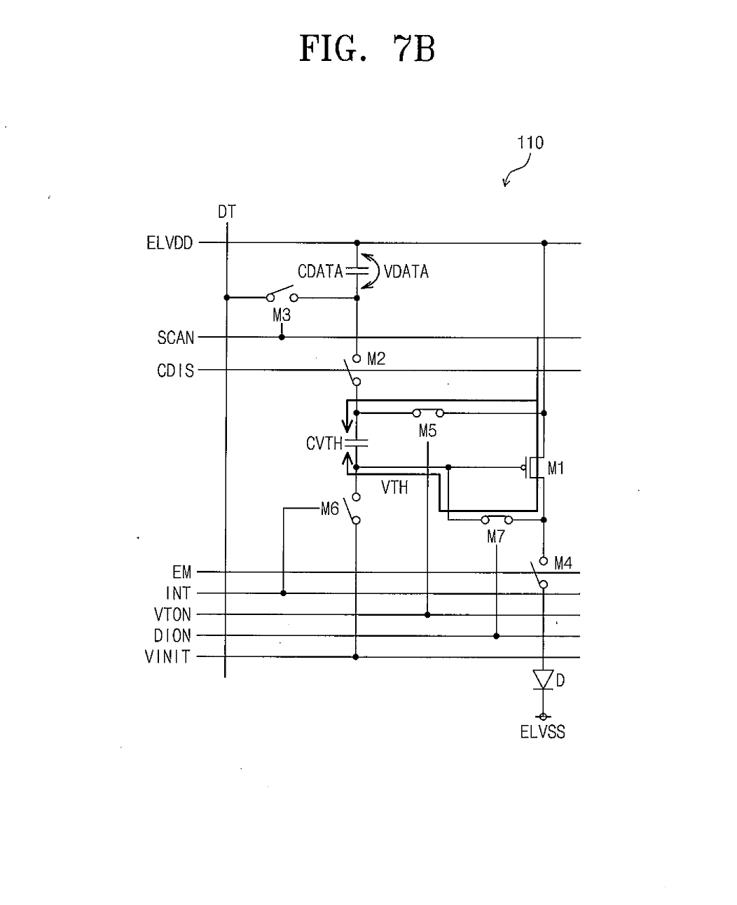

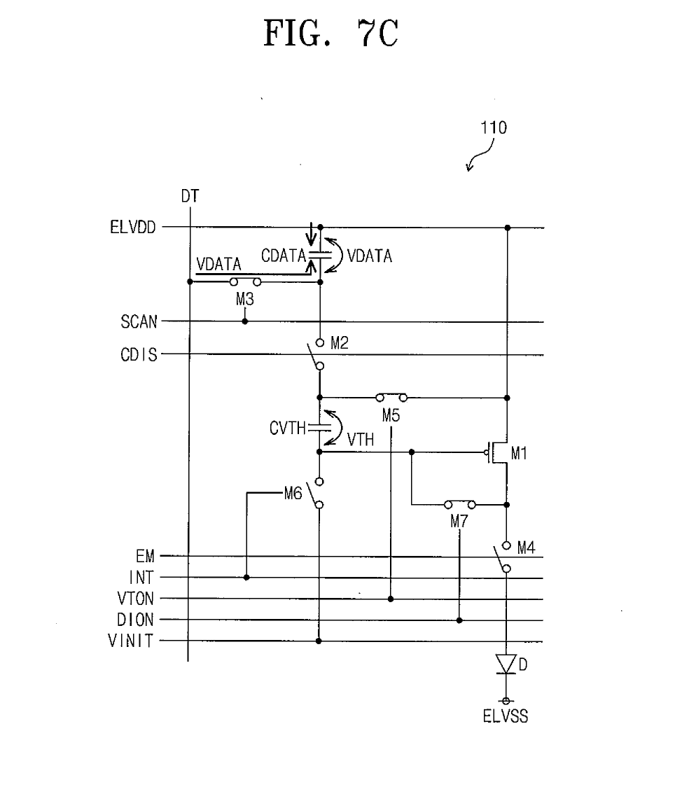

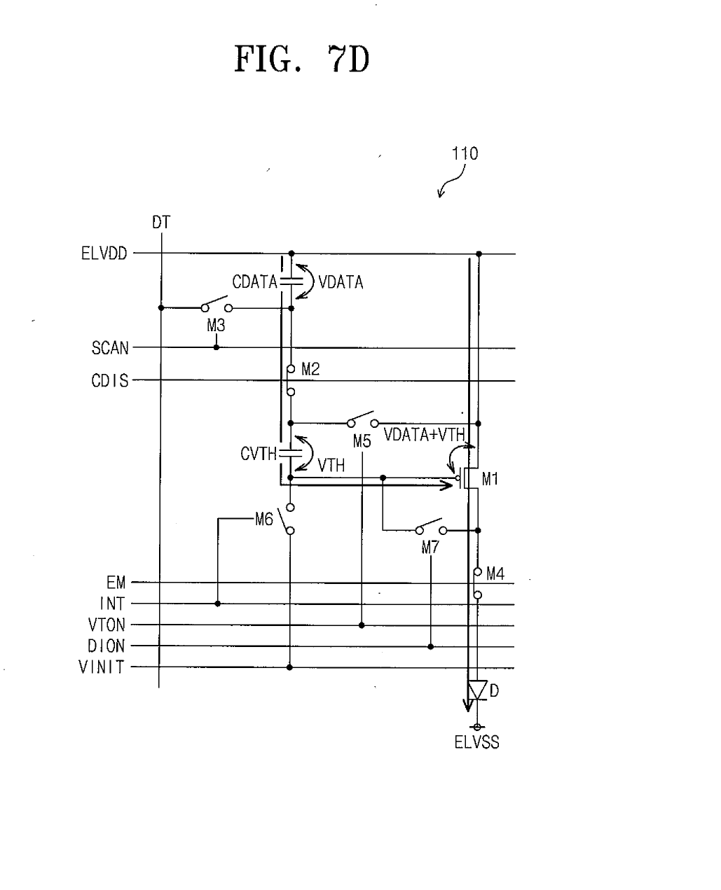

FIG. 6 is a timing graph illustrating the supply of control signals according to the first embodiment of the inventive concept. FIGS. 7A to 7D are views illustrating an operation of the pixel circuit according to the first embodiment of the inventive concept.

FIG. 7A illustrates an operation of the pixel circuit 110 during an initialization period (a) in FIG. 6. FIG. 7B illustrates an operation of the pixel circuit 110 during a VTH compensation period (b) in FIG. 6. FIG. 7C illustrates an operation of the pixel circuit 10 during a display data updating period (c) in FIG. 6. FIG. 7D illustrates an operation of the pixel circuit 110 during a light emission period (d) in FIG. 6.

Referring to FIGS. 6 and 7A, in the pixel circuit 110, the switch transistor M4 is turned off by the EM signal to stop the light emission of the light emitting device D. The switching transistor M2 is turned off by the CDIS signal to electrically disconnect the display data updating circuit 112 from the VTH compensation circuit 114.

In the pixel circuit 110, the switch transistor M5 is turned on by the VTON signal to connect the threshold voltage capacitor CVTH to the source electrode of the driving transistor M1. The initialization transistor M6 is turned on by the INT signal to allow the threshold voltage capacitor CVTH to be initialized to an initialization voltage VINIT. The threshold voltage capacitor CVTH is initialized to the initialization voltage VINIT to initialize the voltage applied to the gate electrode of the driving transistor M1.

Referring to FIGS. 6 and 7B, in the pixel circuit 110, the switch transistor M4 is turned off by the EM signal to stop the light emission of the light emitting device D. The switching transistor M2 is turned off by the CDIS signal to electrically disconnect the display data updating circuit 112 from the VTH compensation circuit 114.

In the pixel circuit 110, the switch transistor M5 is turned on by the VTON signal to connect the threshold voltage capacitor CVTH to the source electrode of the driving transistor M1. The diode transistor M7 is turned on by the DION signal to diode-connect the drain electrode and the gate electrode of the driving transistor M1 to each other. Thus, the voltage applied to the gate electrode of the driving transistor M1 may be a voltage equal to ELVDD-VTH between the first voltage ELVDD and the threshold voltage VTH. The threshold voltage VTH of the driving transistor M1 is maintained (or charged) or substantially maintained in the threshold voltage capacitor CVTH.

Referring to FIGS. 6 and 7C, in the pixel circuit 110, the switch transistor M4 is turned off by the EM signal to stop the light emission of the light emitting device D. The switching transistor M2 is turned off by the CDIS signal to electrically disconnect the display data updating circuit 112 from the VTH compensation circuit 114.

In the pixel circuit 110, the switch transistor M3 is turned on by the SCAN signal to transmit the display data VDATA supplied from the data line DT to the display data capacitor CDATA. Thus, the display data VDATA is maintained (or charged) or substantially maintained in the display data capacitor CDATA.

Referring to FIGS. 6 and 7D, in the pixel circuit 110, the switching transistor M2 is turned on by the CDIS signal to electrically connect the display data updating circuit 112 to the VTH compensation circuit 114. Voltages VDATA and VTH that are respectively maintained in the display data capacitor CDATA and the threshold voltage capacitor CVTH are applied to the gate electrode of the driving transistor M1.

In the pixel circuit 110, the switch transistor M4 is turned on by the EM signal to allow current corresponding to the display data after the VTH compensation to flow into the light emitting device D through the driving transistor M1. Thus, the light emitting device D may emit light.

The display data updating circuit 112 and the threshold voltage compensation circuit 114 are arranged in each of the pixel circuits 110 of the display apparatus 100, and the display data updating circuit 112 and the threshold voltage compensation circuit 114 are electrically connected to or disconnected from each other by the on/off operation of the switching transistor M2.

In the pixel circuit 110, since the display data updating circuit 112 and the VTH compensation circuit 114 may be electrically disconnected from each other, the updating operation for the display data of the display data updating circuit 112 and the VTH compensation operation of the VTH compensation circuit 114 may be individually performed. Thus, since the display apparatus 100 sets the VTH compensation time to a period that does not depend on the horizontal period, the VTH compensation time may increase. As a result, the display apparatus 100 may improve threshold voltage compensation (VTH compensation) performance. Also, since the VTH compensation time increases regardless of the horizontal period, although the horizontal period decreases due to the increase of the resolution, an occurrence of image quality degradation due to the leakage of the VTH compensation time may be prevented or substantially prevented.

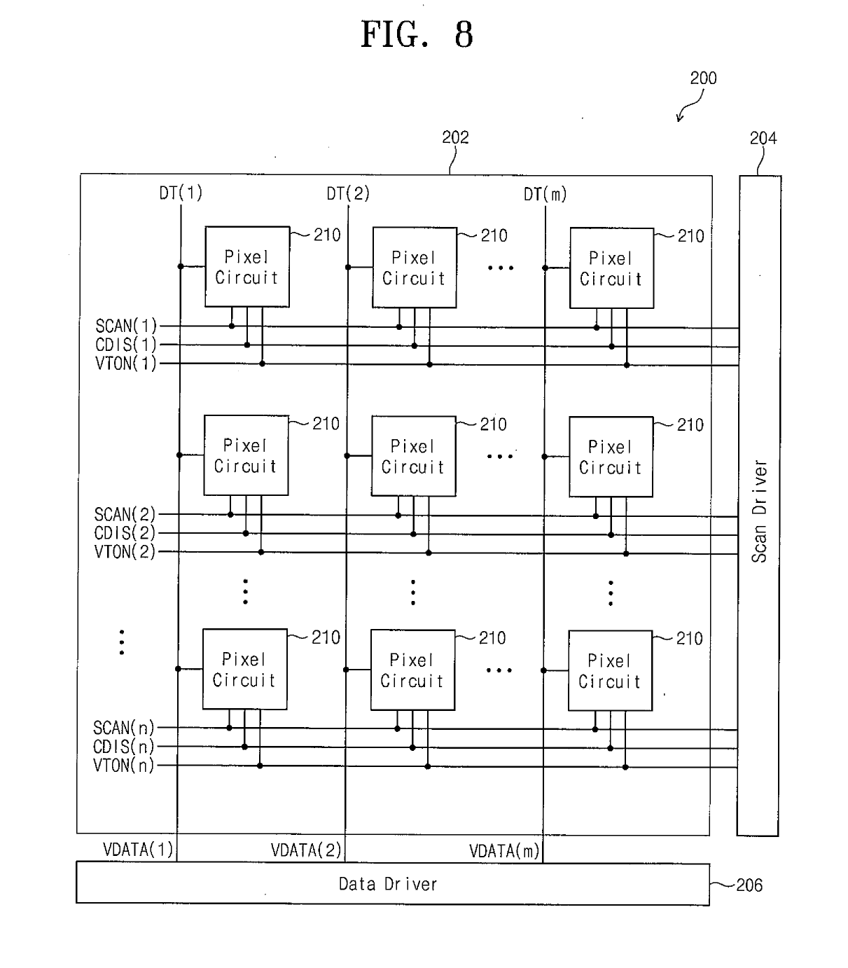

FIG. 8 is a view of a display apparatus according to a second embodiment of the inventive concept.

Referring to FIG. 8, a display apparatus 200 according to a second embodiment of the inventive concept includes a display unit 202, a scan driver 204, and a data driver 206.

The display unit 202 includes a plurality of pixel circuits 210 for displaying an image on the basis of provided display data. The pixel circuits 210 are arranged in a matrix form. The pixel circuits 210 are connected to control lines SCAN, CDIS, and VTON, which extend in a row direction, and signal lines DT that extend in a column direction.

As illustrated in FIG. 1, each of the pixel circuits 210 includes a light emitting device D, a driving transistor, a display data updating circuit, a VTH compensation circuit, and a circuit disconnection switch.

The display data updating circuit of the pixel circuit 210 may have the same or substantially the same structure as that of the display data updating circuit 112 of the pixel circuit 110 illustrated in FIG. 5. The VTH compensation circuit of the pixel circuit 210 may include a threshold voltage capacitor CVTH, a diode transistor (e.g., a diode-connecting transistor) M7, an initialization transistor M6, and a switch transistor M5, like those of the VTH compensation circuit 114 of the pixel circuit 110 illustrated in FIG. 5. However, a connection relationship between the components may be different from that of the VTH compensation circuit of the pixel circuit 110. The structure of the pixel circuit 210 will be described in more detail below.

The scan driver 204 and the data driver 206 of the display apparatus 200 illustrated in FIG. 8 may serve as control units for controlling operations of the pixel circuits 110, like the display apparatus 100 illustrated in FIG. 3.

The scan driver 204 is connected to the control lines SCAN, CDIS, and VTON to selectively provide corresponding control signals to the control lines SCAN, CDIS, and VTON. A SCAN signal provided to the control line SCAN may be a control signal for controlling the initialization timing, the VTH compensation timing, and the updating timing of the display data of the pixel circuits 210 connected to the control line SCAN.

In the VTH compensation circuit of the pixel circuit 210, a threshold voltage of the driving transistor is detected according to a control signal that is equal to or substantially equal to the control signal supplied to the display data updating circuit to update the display data, thereby compensating the threshold voltage.

In the display data updating circuit of the pixel circuit 210, the display data is updated according to a control signal that is equal to or substantially equal to the control signal for detecting and compensating the threshold voltage. In the display data updating circuit, the display data is updated through the same or substantially the same process as that of the display data updating circuit 112 of the pixel circuit 110 in FIG. 5.

A CDIS signal supplied to the control line CDIS may be a control signal for controlling the switch timing of a circuit disconnection switch to disconnect the display data updating circuit from the VTH compensation circuit. A VTON signal supplied in the control line VTON may be a control signal for controlling the light emission and non-emission of the light emitting device.

The data driver 206 is connected to the signal lines DT to selectively supply display data VDATA to the signal lines DT, like the data driver 106 illustrated in FIG. 3.

As illustrated in FIG. 8, although the display apparatus 200 has the same or substantially the same structure as that of the display apparatus 100 of FIG. 3, the number of control lines connected to each of the pixel circuits 210 in FIG. 8 may be different from that of the control lines in the display apparatus 100 of FIG. 3.

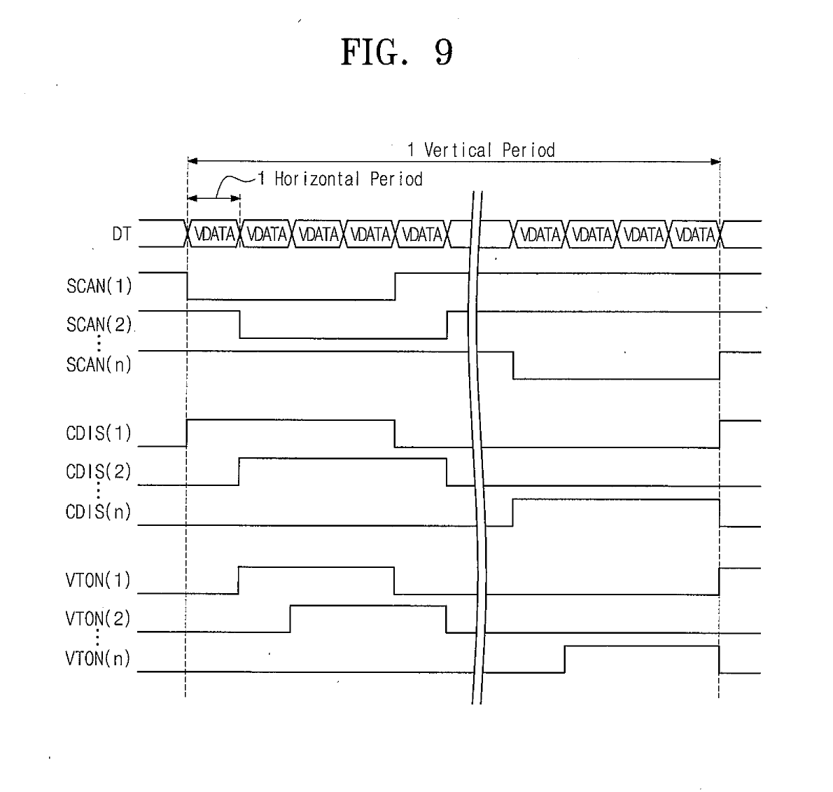

FIG. 9 is a timing diagram illustrating an operation of the display apparatus during 1 vertical period according to the second embodiment of the inventive concept.

Referring to FIG. 9, the VTH compensation and the updating of the display data during the 1 vertical period may be line-successively performed in each pixel circuit 210 by the control signals. In each pixel circuit 210, the display data updating circuit and the VTH compensation circuit may be electrically disconnected from each other by the CDIS signal. The threshold voltage capacitor CVTH is initialized to an initialization voltage VINIT passing through the initialization transistor M6 and the diode transistor M7 by the SCAN signal.

In each of the pixel circuits 210, the switch transistor M4 is turned off by the VTON signal to diode-connect a drain electrode and gate electrode of the driving transistor M1 to each other, thereby performing the VTH compensation.

In each of the pixel circuits 210, the switch transistor M4 is turned off by the VTON signal, the display data updating circuit and the VTH compensation circuit are electrically disconnected from each other by the CDIS signal, and the updating operation for the display data may be performed by the SCAN signal.

Unlike the operation (the VTH compensation operation and the updating operation for the display data in the pixel circuit 110) of the display apparatus 100, the operation (the VTH compensation operation and the updating operation for the display data in the pixel circuit 210) may be performed through the SCAN signal. Thus, in the operation of the display apparatus 200, the control signal supplied to the display data updating circuit and the VTH compensation circuit may be shared with each other.

Due to this difference, the display apparatus 200 may reduce the number of control signals supplied to the pixel circuit when compared to that of the display apparatus 100 according to the first embodiment. Thus, the display apparatus 200 may reduce the number of control units (e.g., controllers) when compared to that of the display apparatus 100 according to the first embodiment.

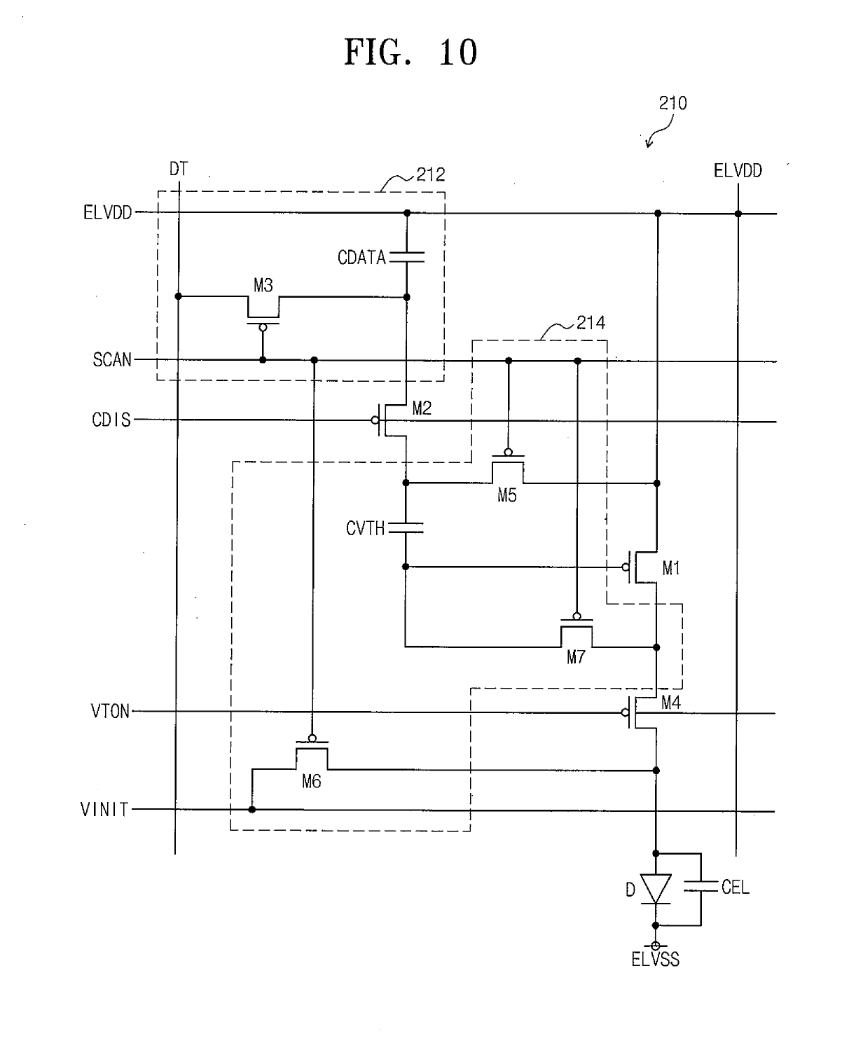

FIG. 10 is a view of the pixel circuit according to the second embodiment of the inventive concept.

Referring to FIG. 10, the pixel circuit 210 includes a light emitting device D, a driving transistor M1, a display data updating circuit 212, a threshold voltage compensation circuit 214, a switching transistor M2 (e.g., a first switch transistor), and a switch transistor M4 for controlling light emission and non-emission of the light emitting device D. A CEL illustrated in FIG. 10 may be a parasitic capacitor of the light emitting device D.

The display data updating circuit 212 and the threshold voltage compensation circuit 214 are connected to the switching transistor M2, and are electrically connected to or disconnected from each other by the on/off operation of the switching transistor M2, like the display data updating circuit 112 and the threshold voltage compensation circuit 114 illustrated in FIG. 5. The switch transistor M4 may be turned on/off by the VTON signal provided to the gate electrode of the switch transistor M4 to control the light emission and non-emission of the light emitting device D.

The display data updating circuit 212 has the same or substantially the same structure and function as those of the display data updating circuit 112 illustrated in FIG. 5.

The threshold voltage compensation circuit 214 includes a threshold voltage capacitor CVTH, a diode transistor (e.g., a diode-connecting transistor) M7, an initialization transistor M6, and a switch transistor M5 (e.g., a third switch transistor).

Unlike the threshold voltage compensation circuit 114 illustrated in FIG. 5, the initialization transistor M6 of the threshold voltage compensation circuit 214 is not connected to the gate electrode of the driving transistor M1, but may be connected to the anode electrode of the light emitting device D.

Accordingly, the display apparatus 200 according to the second embodiment may have a reduced number of the control signals supplied from the scan driver to the pixel circuit 210 when compared to that of the display apparatus 100 according to the first embodiment. Thus, the display apparatus 200 may reduce a size of the scan driver when compared to that of the display apparatus 100 according to the first embodiment.

Also, the display apparatus 200 discharges the charges accumulated in the parasitic capacitor CEL of the light emitting device D by the components of the threshold voltage compensation circuit 214 to reduce image quality degradation, such as black floating that may occur when a black level is displayed.

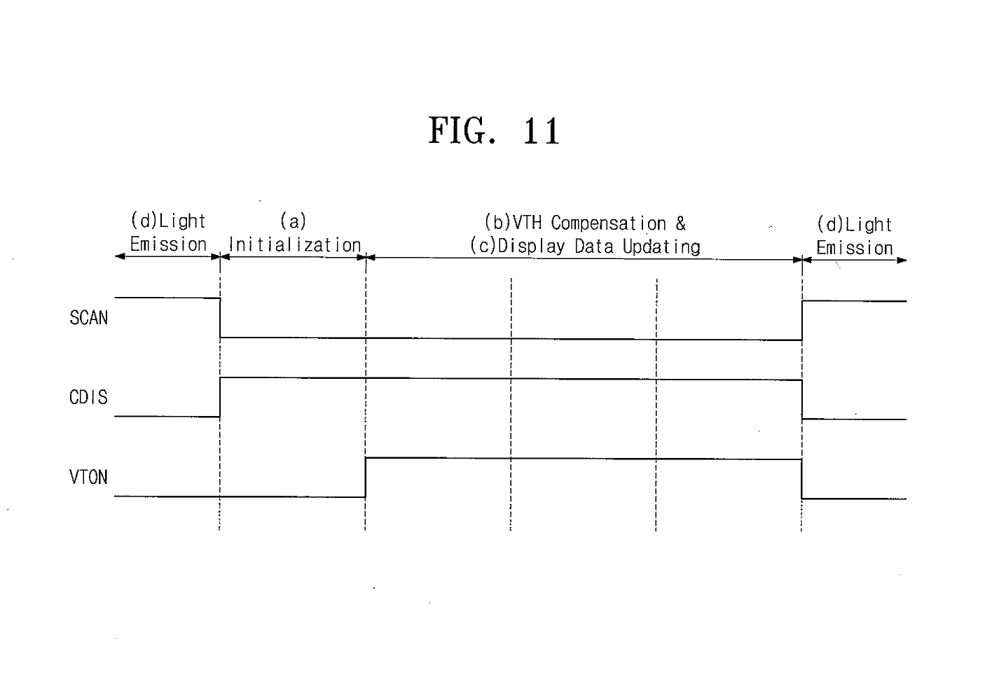

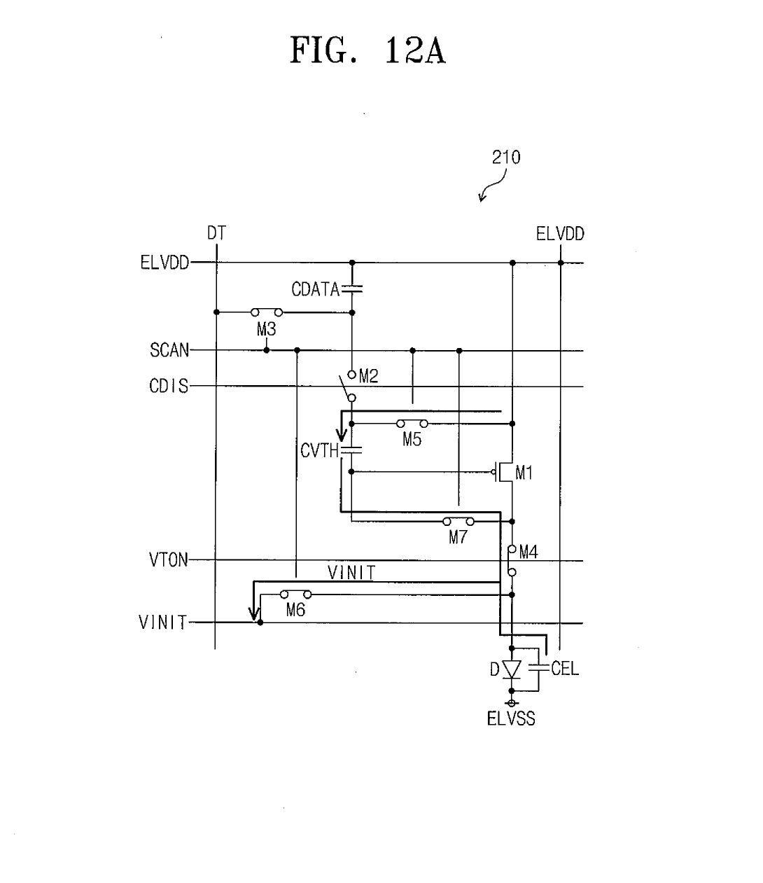

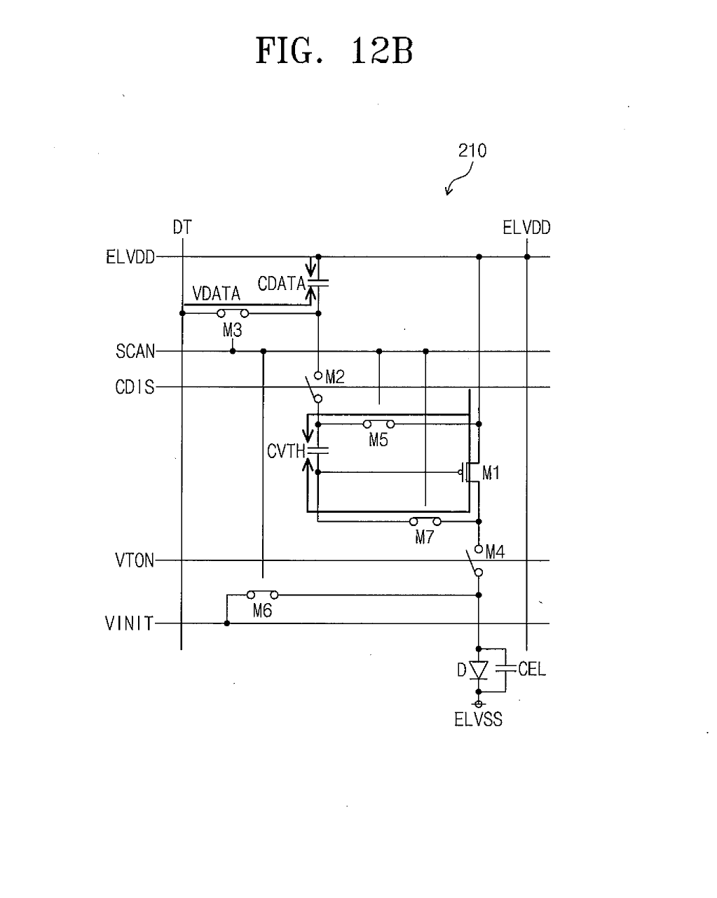

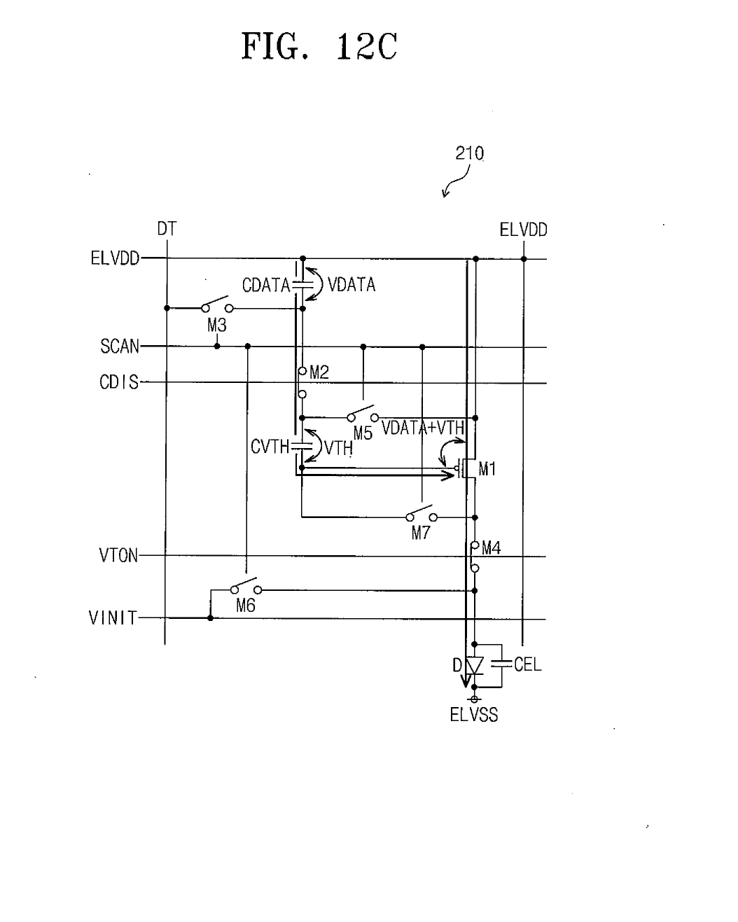

FIG. 11 is a timing graph illustrating the supply of control signals according to the second embodiment of the inventive concept. FIGS. 12A to 12C are views illustrating an operation of the pixel circuit according to the second embodiment of the inventive concept.

FIG. 12A illustrates an operation of the pixel circuit 210 during an initialization period (a) of FIG. 11. FIG. 12B illustrates an operation of the pixel circuit 210 during a VTH compensation period (b) and a display data updating period (c) of FIG. 11. FIG. 12C illustrates an operation of the pixel circuit 210 during a light emission period (d) of FIG. 11.

Referring to FIGS. 11 and 12A, in the pixel circuit 210, the switching transistor M2 is turned off by the CDIS signal to electrically disconnect the display data updating circuit 212 from the VTH compensation circuit 214.

In the pixel circuit 210, the switch transistor M3, the switch transistor M5, the initialization transistor M6, and the diode transistor M7 are turned on by the SCAN signal, and the switch transistor M4 is turned on by the VTON signal. The threshold voltage capacitor CVTH is initialized to an initialization voltage VINIT passing through the initialization transistor M6 and the diode transistor M7, which are turned on by the SCAN signal. Also, the charges accumulated in the parasitic capacitor CEL of the light emitting device D may be discharged via the initialization transistor M6 by the SCAN signal.

Although the switch transistor M3 is turned on by the SCAN signal, since the display data VDATA is not supplied to the data line DT, the updating operation for the display data may not be performed in the pixel circuit 210.

In the display apparatus 200, since the display data updating circuit 212 and the VTH compensation circuit 214 may be electrically disconnected from each other, the initialization period and the display data updating period may operate to overlap each other.

Referring to FIGS. 11 and 12B, in the pixel circuit 210, the switching transistor M2 is turned off by the CDIS signal to electrically disconnect the display data updating circuit 212 from the VTH compensation circuit 214.

In the pixel circuit 210, the switch transistor M3, the switch transistor M5, the initialization transistor M6, and the diode transistor M7 are turned on by the SCAN signal, and the switch transistor M4 is turned off by the VTON signal.

Since the drain electrode and gate electrode of the driving transistor M1 are diode-connected to each other in the state in which the threshold voltage capacitor CVTH is connected to the source electrode of the driving transistor M1 by the SCAN signal in the pixel circuit 210, a voltage applied to the gate electrode of the driving transistor M1 may be a voltage equal to or substantially equal to ELVDD-VTH between the first voltage ELVDD and the threshold voltage VTH. The threshold voltage VTH of the driving transistor M1 is maintained (or charged) or substantially maintained in the threshold voltage capacitor CVTH.

Since the display data VDATA is supplied to the data line DT in the state in which the switch transistor M3 is turned on by the SCAN signal, the display data VDATA is transmitted to the display data capacitor CDATA. Thus, the display data VDATA is maintained (or charged) or substantially maintained in the display data capacitor CDATA.

Referring to FIGS. 11 and 12C, in the pixel circuit 210, the switch transistor M3, the switch transistor M5, the initialization transistor M6, and the diode transistor M7 are turned off by the SCAN signal. In the pixel circuit 210, the switching transistor M2 is turned on by the CDIS signal to electrically connect the display data updating circuit 212 to the VTH compensation circuit 214. Thus, voltages VDATA and VTH that are respectively maintained in the display data capacitor CDATA and the threshold voltage capacitor CVTH are applied to the gate electrode of the driving transistor M1.

In the pixel circuit 210, the switch transistor M4 is turned on by the VTON signal to allow current corresponding to the display data after the VTH compensation to flow into the light emitting device D through the driving transistor M1. Thus, the light emitting device D emits light.

In the pixel circuit 210, the updating operation for the display data of the display data updating circuit 212 and the threshold voltage compensation operation of the driving transistor M1 of the VTH compensation circuit 214 are performed concurrently (e.g., simultaneously or at the same time).

Like the pixel circuit 110 according to the first embodiment, the display data updating circuit 212 and the VTH compensation circuit 214 are arranged in each of the pixel circuits 210 of the display apparatus 200. The display data updating circuit 212 and the VTH compensation circuit 214 are electrically connected to or disconnected from each other by the on/off operation of the switching transistor M2.

Thus, like the pixel circuit 110 according to the first embodiment, the updating operation for the display data of the display data updating circuit 212 and the VTH compensation operation of the VTH compensation circuit 214 may be individually performed. As a result, the display apparatus 200 may have the same or substantially the same feature as that of the display apparatus 100 according to the first embodiment.

The display apparatus 200 according to the second embodiment may reduce the number of control signals supplied from the scan driver to the pixel circuit when compared to that of the display apparatus 100 according to the first embodiment. Thus, the display apparatus 200 may reduce a size of the scan driver when compared to that of the display apparatus 100 according to the first embodiment.

Also, the display apparatus 200 discharges the electric charges accumulated in the parasitic capacitor CEL of the light emitting device D to reduce image quality degradation, such as black floating that may occur when a black level is displayed.

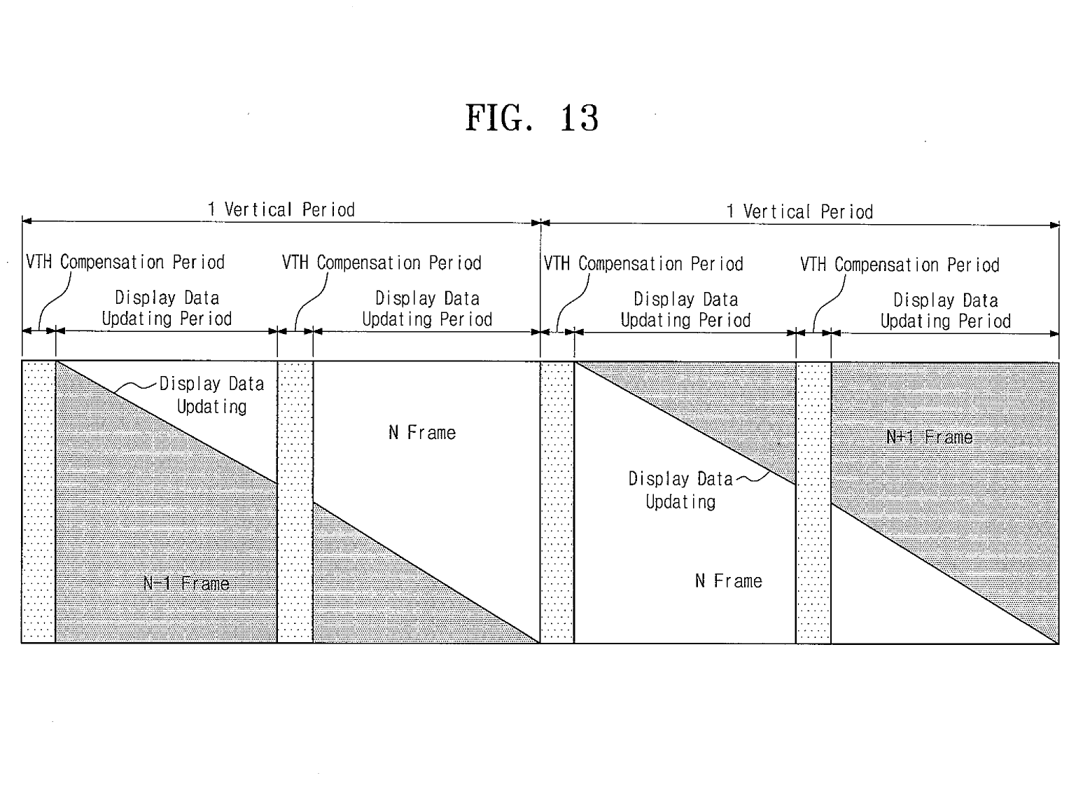

FIG. 13 is a timing chart illustrating an operation of a display apparatus according to a third embodiment of the inventive concept.

Referring to FIG. 13, 1 vertical period includes a VTH compensation period during which VTH compensation is performed, and a display data updating period during which updating of display data is performed. Pixel circuits of the display apparatus may perform the VTH compensation operation for the VTH compensation period concurrently (e.g., simultaneously or at the same time). The pixel circuits may line-successively perform the updating of the display data during the display data updating period.

The display apparatus operating according to the timing chart illustrated in FIG. 13 electrically disconnects the display data updating circuit from the VTH compensation circuit when the display data updating and the threshold voltage compensation of the driving transistor are performed. Thus, the display data updating and the VTH compensation may be performed at separate timing.

When the VTH compensation and the display data updating are completed, and the light emitting device emits light, the display apparatus electrically connects the display data updating circuit to the VTH compensation circuit to electrically connect a display data capacitor CDATA to a threshold voltage capacitor CVTH, and then controls light emission current of the driving transistor.

Also, in the display apparatus, the VTH compensation is performed several times (e.g., two times) during the 1 vertical period as illustrated in FIG. 13. Since the VTH compensation is performed several times during the 1 vertical period, the threshold voltage capacitor CVTH that is arranged in the VTH compensation circuit of each of the pixel circuits may decrease in size to realize high resolution.

Although the 1 vertical period includes two VTH compensation periods in FIG. 13, the inventive concept is not limited thereto. For example, the 1 vertical period may include at least three VTH compensation periods.

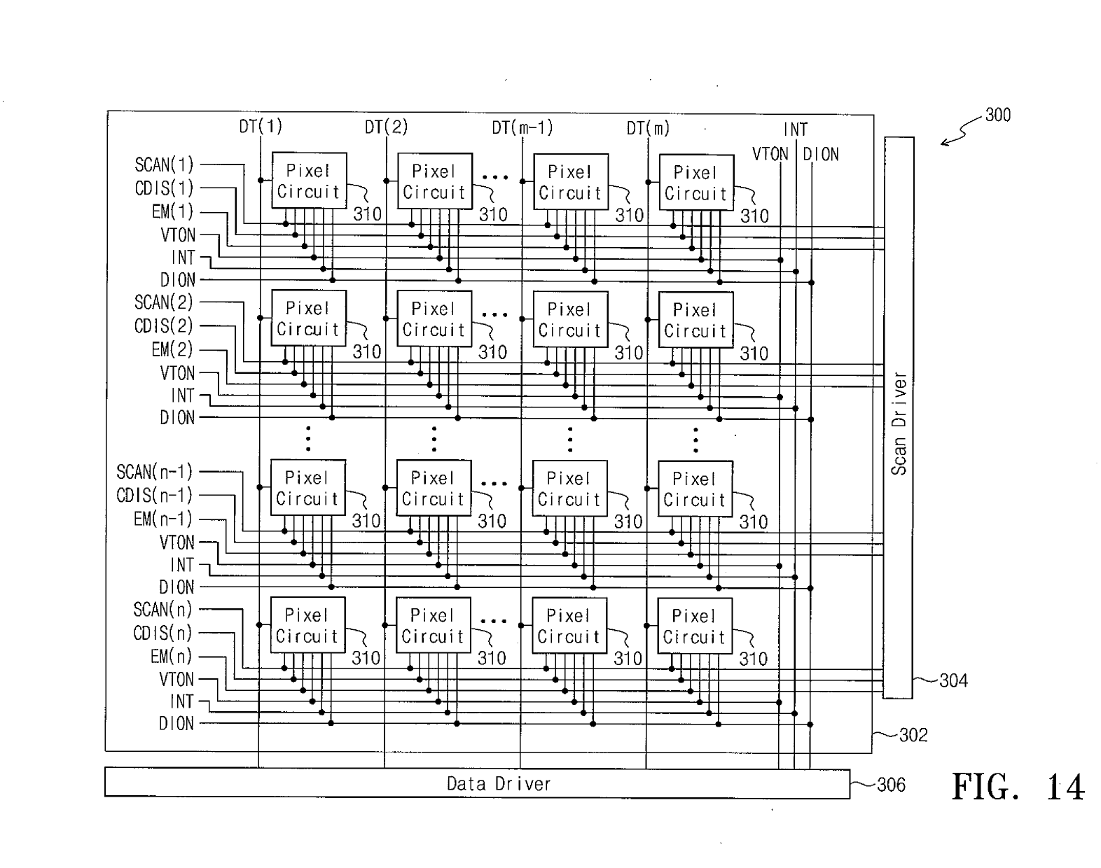

FIG. 14 is a view of the display apparatus according to the third embodiment of the inventive concept.

Referring to FIG. 14, a display apparatus 300 includes a display unit 302, a scan driver 304, and a data driver 306. The display unit 302 includes a plurality of pixel circuits 310 arranged in a matrix form and for displaying an image on the basis of provided display data. The pixel circuits 310 are connected to control lines SCAN, CDIS, INT, VTON, DION, and EM, which extend in a row direction, and a signal lines DT that extend in a column direction.

The scan driver 304 and the data driver 306 which are illustrated in FIG. 14 serve as control units (e.g., controllers) for controlling the display data updating of the pixel circuit 310, the threshold voltage compensation of the driving transistor, and the light emission of the light emitting device.

The scan driver 304 is connected to the control lines SCAN, CDIS, and EM to selectively provide corresponding control signals to the control lines SCAN, CDIS, and EM.

The data driver 306 is connected to the signal lines DT to selectively supply display data VDATA to the signal lines DT. Also, the data driver 306 is selectively connected to the control lines VTON, INT, and DION to selectively supply corresponding control signals to the control lines VTON, INT, and DION.

The display apparatus 300 may have the same or substantially the same structure as that of the display apparatus 100 illustrated in FIG. 3, except for the control lines VTON, INT, and DION are connected to the data driver 306, and the operation timing of the display apparatus 300 is different from that of the display apparatus 100.

A SCAN signal supplied to the control line SCAN may be a control signal for controlling updating of the timing of the display data. A CDIS signal supplied to the control line CDIS may be a control signal for controlling the switch timing of a circuit disconnection switch that may disconnect a display data updating circuit from a VTH compensation circuit.

An EM signal supplied to the control line EM may be a control signal for controlling the emission and non-emission of the light emitting device. Each of a VTON signal supplied to the control line VTON and a DION signal supplied to the control line DION may be a control signal for controlling the VTH compensation timing. An INT signal supplied into the control line INT may be a control signal for controlling the initialization timing of the pixel circuit 310.

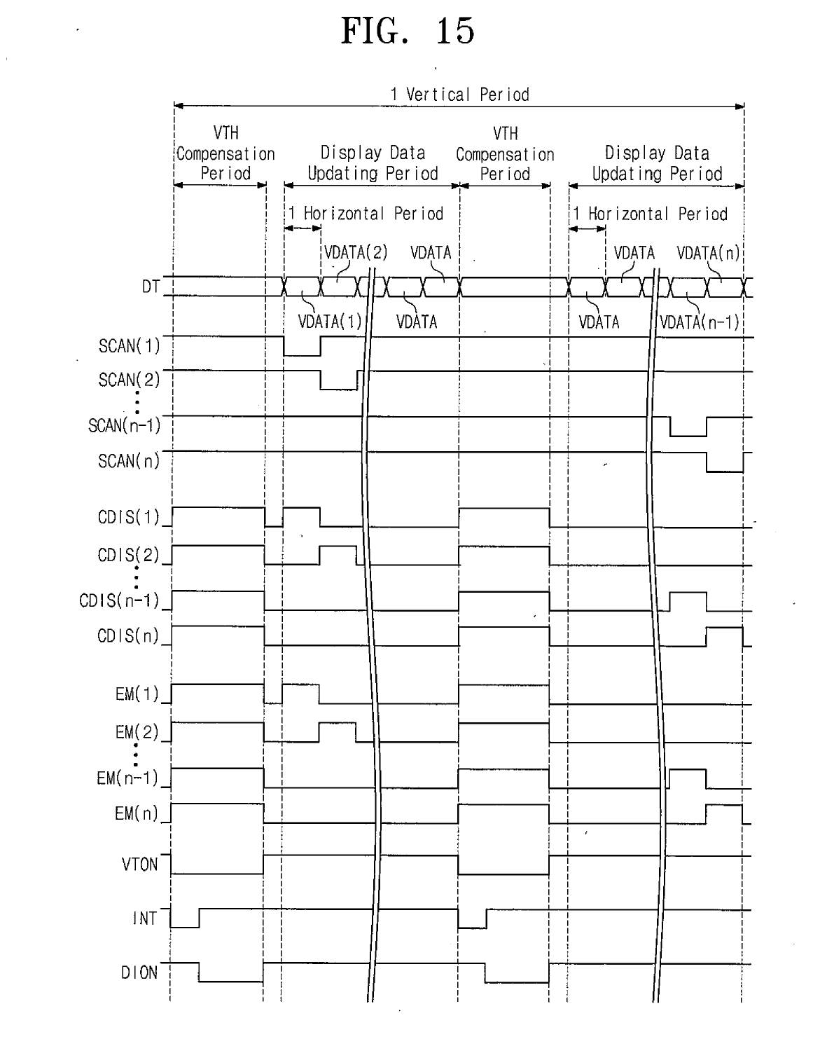

FIG. 15 is a timing diagram illustrating the operation of the display apparatus during 1 vertical period according to the third embodiment of the inventive concept.

Referring to FIG. 15, the VTH compensation and the display data updating during the 1 vertical period are controlled by control signals generated from the scan driver 304 and the data driver 306.

The VTH compensation operation during the 1 vertical period is performed several times (e.g., two times) concurrently (e.g., simultaneously or at the same time) for all the pixel circuits 310. The updating operation for the display data during the 1 vertical period is line-successively performed for the pixel circuits 310.

Although the VTH compensation period and the display data updating period are illustrated as separate periods in FIG. 15, the periods of the 1 vertical period of the display apparatus according to the third embodiment is not limited thereto. For example, as illustrated in FIG. 1, since the display apparatus 300 electrically disconnects the display data updating circuit from the VTH compensation circuit by a switch transistor included in a circuit disconnection switch, the VTH compensation period and the display data period may overlap each other in the display apparatus 300.

The VTH compensation operation for each pixel circuit 310 may be performed as follows.

In the pixel circuit 310, the light emission may be stopped by the EM signal, and concurrently (e.g., simultaneously), the display data updating circuit and the VTH compensation circuit may be electrically disconnected from each other by the CDIS signal. In a state in which a threshold voltage capacitor CVTH is connected to the source electrode of the driving transistor by the VTON signal, the threshold voltage capacitor CVTH may be initialized by the INT signal. The drain electrode and gate electrode of the driving transistor may be diode-connected to each other by the DION signal to perform the VTH compensation.

The display data updating operation for each pixel circuit 310 may be performed as follows.

In the pixel circuit 310, in a state in which the light emission is stopped by the EM signal, and concurrently (e.g., simultaneously), the display data updating circuit and the VTH compensation circuit are electrically disconnected from each other by the CDIS signal, the display data updating may be performed by the SCAN signal.

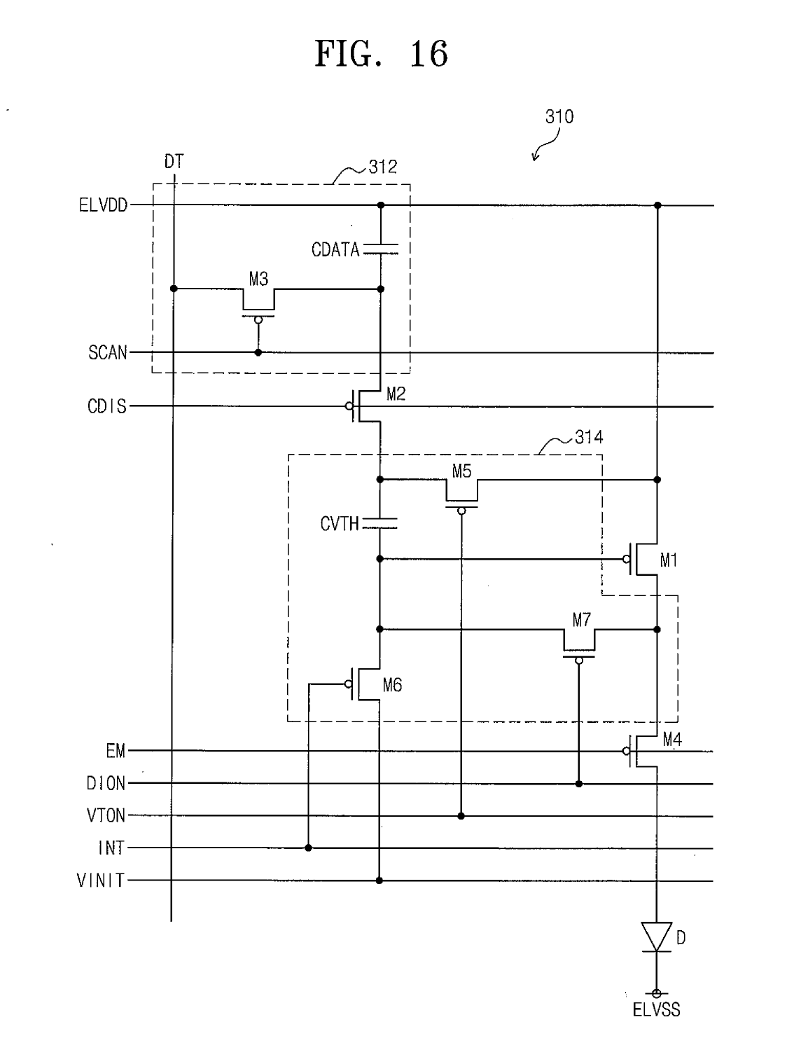

FIG. 16 is a view of the pixel circuit according to the third embodiment of the inventive concept.

Referring to FIG. 16, the pixel circuit 310 includes a light emitting device D, a driving transistor M1, a display data updating circuit 312, a threshold voltage compensation circuit 314, a switching transistor M2 (e.g., a first switch transistor), and a switch transistor M4 for controlling emission and non-emission of the light emitting device D.

The display data updating circuit 312 includes a switch transistor M3 (e.g., a second switch transistor) for controlling display data updating timing, and a display data capacitor CDATA.

The threshold voltage compensation circuit 314 includes a threshold voltage capacitor CVTH, a diode transistor (e.g., a diode-connecting transistor) M7, an initialization transistor M6, and a switch transistor M5 (e.g., a third switch transistor).

The pixel circuit 310 illustrated in FIG. 16 has the same or substantially the same structure as the pixel circuit 110 illustrated in FIG. 5. Thus, hereinafter, repeat description thereof will be omitted.

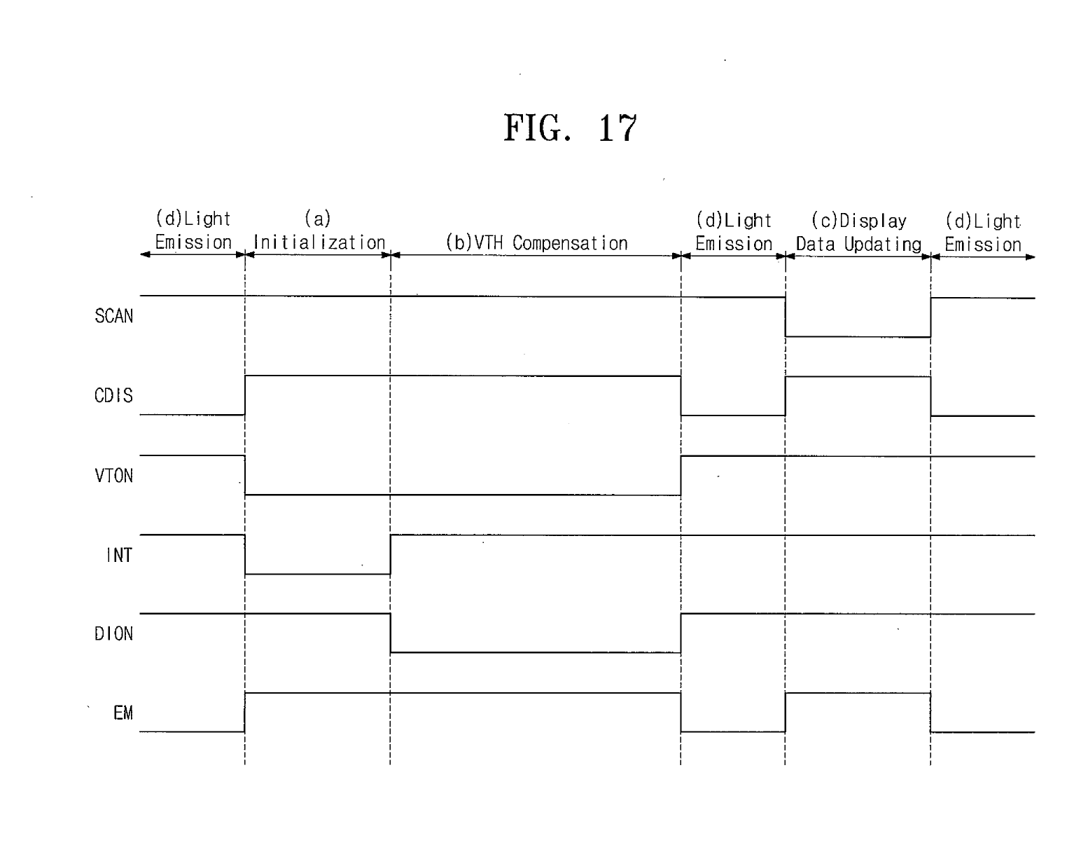

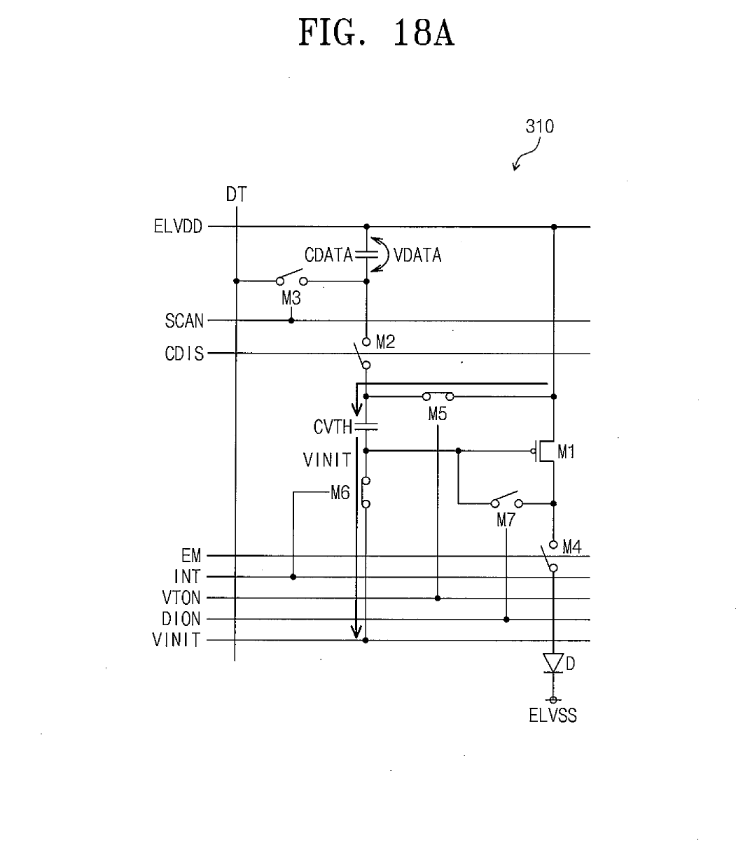

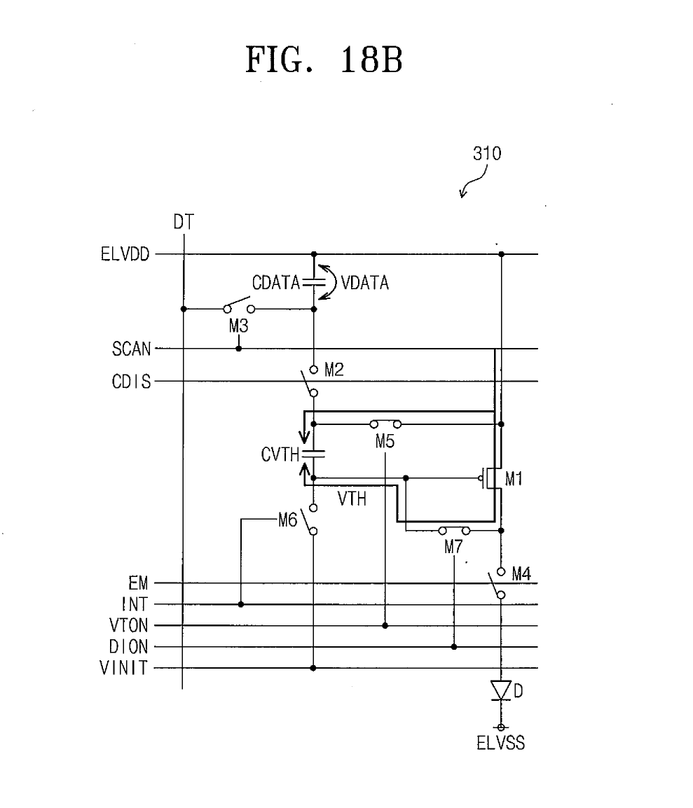

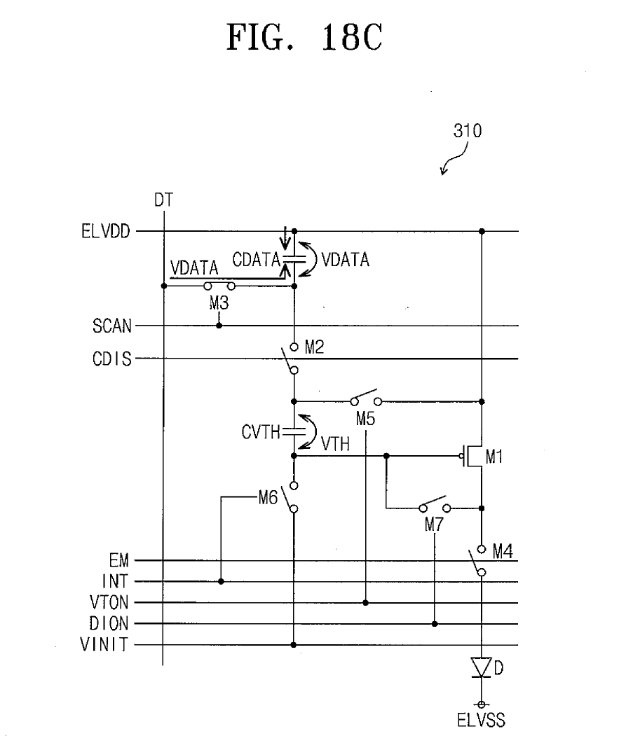

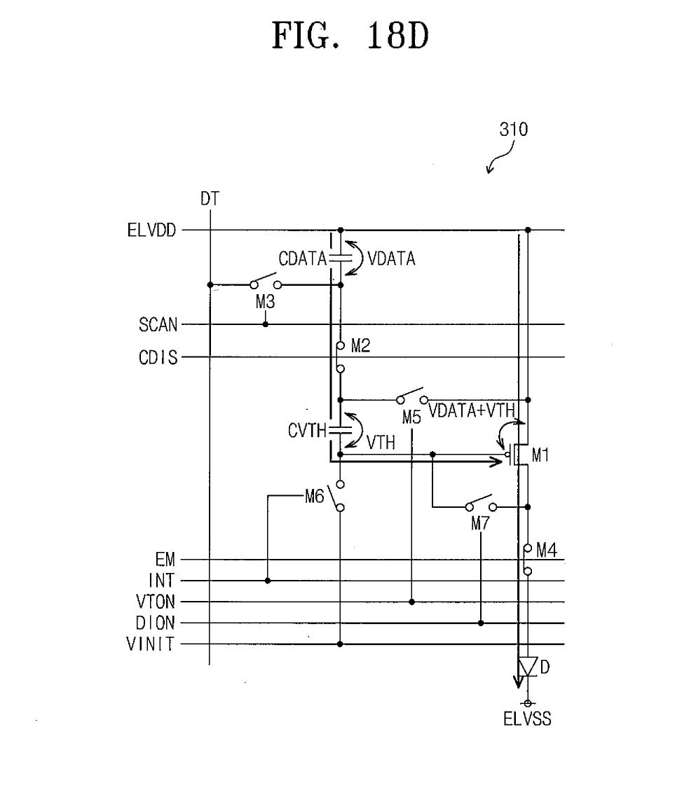

FIG. 17 is a timing graph illustrating the supply of control signals according to the third embodiment of the inventive concept. FIGS. 18A to 18D are views illustrating an operation of the pixel circuit according to the third embodiment of the inventive concept.

FIG. 18A illustrates an operation of the pixel circuit 310 during an initialization period (a) of FIG. 17. FIG. 18B illustrates an operation of the pixel circuit 310 during the VTH compensation period (b) in FIG. 17. FIG. 18C illustrates an operation of the pixel circuit 310 during the display data updating period (c) in FIG. 17. FIG. 18D illustrates an operation of the pixel circuit 310 during a light emission period (d) in FIG. 17.

Although one VTH compensation period (b) is illustrated for convenience of description in FIG. 17, as described above, the VTH compensation operation may be performed several times during the 1 vertical period in the pixel circuits 310 of the display apparatus 300.

Referring to FIGS. 17 and 18A, in the pixel circuit 310, the switch transistor M4 is turned off by the EM signal to stop the light emission of the light emitting device D. The switching transistor M2 is turned off by the CDIS signal to electrically disconnect the display data updating circuit 312 from the VTH compensation circuit 314.

In the pixel circuit 310, the switch transistor M5 is turned on by the VTON signal to connect the threshold voltage capacitor CVTH to the source electrode of the driving transistor M1. The initialization transistor M6 is turned on by the INT signal to allow the threshold voltage capacitor CVTH to be initialized to an initialization voltage VINIT. The threshold voltage capacitor CVTH is initialized to the initialization voltage VINIT to initialize the voltage applied to the gate electrode of the driving transistor M1.

Referring to FIGS. 17 and 18B, in the pixel circuit 310, the switch transistor M4 is turned off by the EM signal to stop the light emission of the light emitting device D. The switching transistor M2 is turned off by the CDIS signal to electrically disconnect the display data updating circuit 312 from the VTH compensation circuit 314.

In the pixel circuit 310, the switch transistor M5 is turned on by the VTON signal to connect the threshold voltage capacitor CVTH to the source electrode of the driving transistor M1. The diode transistor M7 is turned on by the DION signal to diode-connect the drain electrode and the gate electrode of the driving transistor M1 to each other. Thus, the voltage applied to the gate electrode of the driving transistor M1 may be a voltage equal to or substantially equal to ELVDD-VTH between the first voltage ELVDD and the threshold voltage VTH. The threshold voltage VTH of the driving transistor M1 is maintained or substantially maintained in the threshold voltage capacitor CVTH.

Referring to FIGS. 17 and 18C, in the pixel circuit 310, the switch transistor M4 is turned off by the EM signal to stop the light emission of the light emitting device D. The switching transistor M2 is turned off by the CDIS signal to electrically disconnect the display data updating circuit 312 from the VTH compensation circuit 314.

In the pixel circuit 310, the switch transistor M3 is turned on by the SCAN signal to transmit the display data VDATA supplied from the data line DT to the display data capacitor CDATA. Thus, the display data VDATA is maintained or substantially maintained in the display data capacitor CDATA.

Referring to FIGS. 17 and 18D, in the pixel circuit 310, the switching transistor M2 is turned on by the CDIS signal to electrically connect the display data updating circuit 312 to the VTH compensation circuit 314. Voltages VDATA and VTH that are respectively maintained in the display data capacitor CDATA and the threshold voltage capacitor CVTH are applied to the gate electrode of the driving transistor M1.

In the pixel circuit 310, the switch transistor M4 is turned on by the EM signal to allow current corresponding to the display data after the VTH compensation to flow into the light emitting device D through the driving transistor M1. Thus, the light emitting device D may emit light.

The display data updating circuit 312 and the threshold voltage compensation circuit 314 are arranged in each of the pixel circuits 310 of the display apparatus 300, and the display data updating circuit 312 and the threshold voltage compensation circuit 314 are electrically connected to or disconnected from each other by the on/off operation of the switching transistor M2.

In the pixel circuit 310, since the display data updating circuit 312 and the VTH compensation circuit 314 may be electrically disconnected from each other, the updating operation for the display data of the display data updating circuit 312 and the VTH compensation operation of the VTH compensation circuit 314 may be individually performed at separate timing. Thus, the VTH compensation during the 1 vertical period may be performed several times concurrently (e.g., simultaneously or at the same time) for all of the pixel circuits 310.

Since the display apparatus 300 sets the VTH compensation time to a period that does not depend on the horizontal period, the VTH compensation time may increase. As a result, the display apparatus 300 may improve threshold voltage compensation (VTH compensation) performance. Also, since the VTH compensation time increases regardless of the horizontal period, although the horizontal period decreases due to the increase of the resolution, an occurrence of image quality degradation due to the leakage of the VTH compensation time may be prevented or substantially prevented.

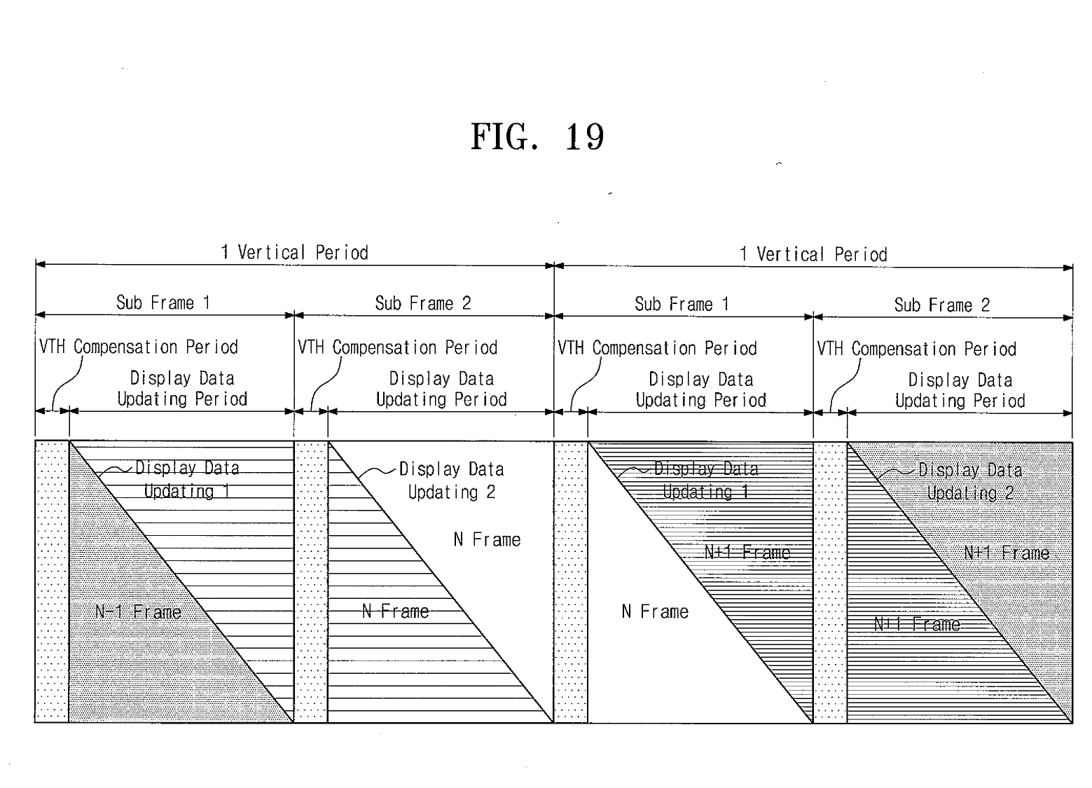

FIG. 19 is a timing chart illustrating an operation of a display apparatus according to a fourth embodiment of the inventive concept.

Referring to FIG. 19, 1 vertical period includes two sub frames. VTH compensation and display data updating may be performed for each of the sub frames. In each of the sub frames illustrated in FIG. 19, the VTH compensation, the display data updating, and the control of light emission of a light emitting device are performed with the same or substantially the same operation as those of the display apparatus 300 according to the third embodiment.

In the display apparatus according to the fourth embodiment, a control operation for pixel circuits arranged in odd-numbered lines is performed during one sub frame (e.g., sub frame 1, hereinafter, referred to as a first sub frame) of the two sub frames. Also, a control operation for pixel circuits arranged in even-numbered lines is performed in the other sub frame (e.g., sub frame 2, hereinafter, referred to as a second sub frame) of the two sub frames.

However, a control operation for any combination of the pixel circuits may be performed in the first and second sub frames, without being limited to the odd-numbered pixel circuits and the even-numbered pixel circuits.

An operation of the display apparatus according to the fourth embodiment is not limited to an operation timing illustrated in FIG. 19. For example, in some embodiments, 1 vertical period may include at least three sub frames. Here, VTH compensation and display data updating may be performed for each of the sub frames. Also, if the 1 vertical period includes at least three sub frames, a control operation for the pixel circuits of the lines corresponding to each of the sub frames may be performed.

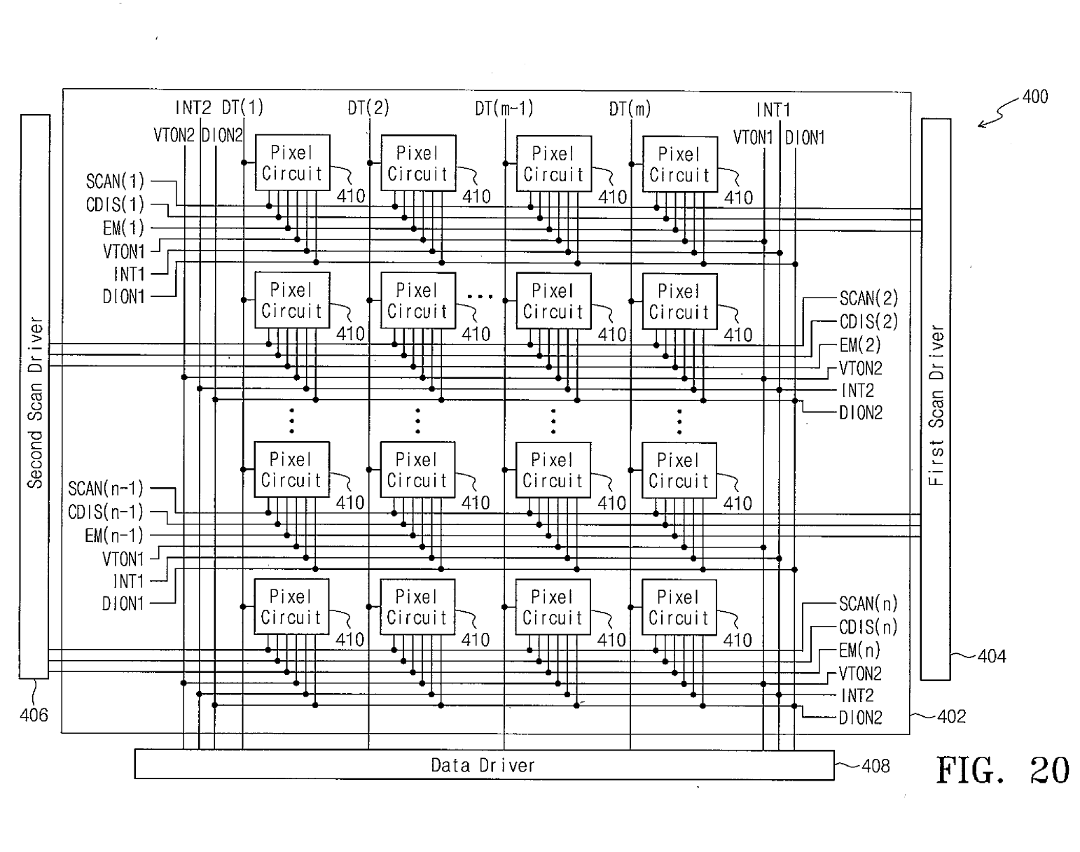

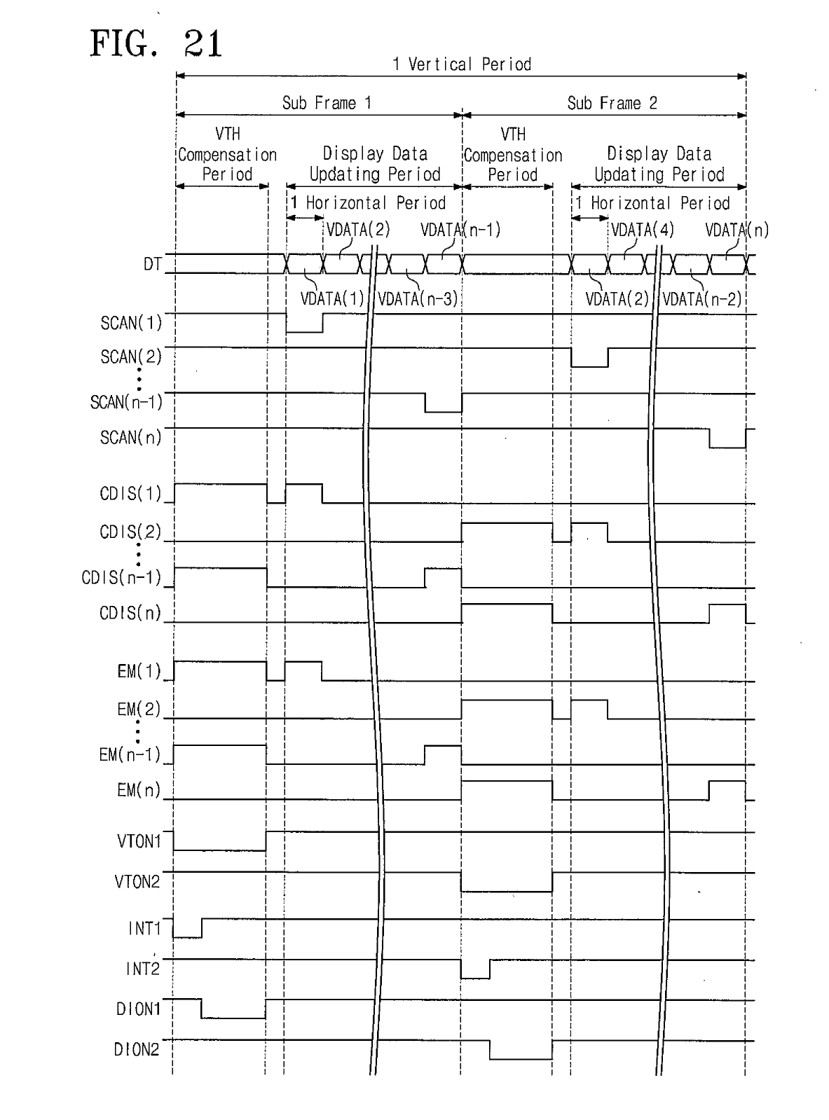

FIG. 20 is a view of the display apparatus according to the fourth embodiment of the inventive concept. FIG. 21 is a timing diagram illustrating an operation of the display apparatus during the 1 vertical period according to the fourth embodiment of the inventive concept.

Referring to FIGS. 20 and 21, a display apparatus 400 includes a display unit 402, a first scan driver 404, a second scan driver 406, and a data driver 408. The display unit 402 includes a plurality of pixel circuits 410 arranged in a matrix form and for displaying an image on the basis of provided display data.

The pixel circuits 410 are connected to control lines SCAN, CDIS, INT, VTON, DION, and EM, which extend in a row direction, and a signal lines DT that extend in a column direction. Each of the pixel circuits 410 has the same or substantially the same structure as that of the pixel circuit 310 illustrated in FIG. 16.

The pixel circuits 410 of odd-numbered lines (or rows) receive control signals for controlling the display data updating, the threshold voltage compensation of a driving transistor M1, and the light emission of a light emitting device D from the first scan driver 404 and the data driver 408.

The pixel circuits 410 of even-numbered lines (or rows) receive control signals for controlling the display data updating, the threshold voltage compensation of the driving transistor M1, and the light emission of the light emitting device D from the second scan driver 406 and the data driver 408.

The control signals outputted from the first scan driver 404 and the data driver 408 of the display apparatus 400 are provided to the pixel circuits 410 of the odd-numbered lines during the first sub frame. The first scan driver 404 and the data driver 408 may be defined as a first driver for controlling the pixel circuits 410 of the odd-numbered lines.

The control signals outputted from the second scan driver 406 and the data driver 408 of the display apparatus 400 are provided to the pixel circuits 410 of the even-numbered lines during the second sub frame. The second scan driver 406 and the data driver 408 may be defined as a second driver for controlling the pixel circuits 410 of the even-numbered lines.

The first and second drivers according to an embodiment of the inventive concept may be an external control device of the display apparatus 400.

The display apparatus 400 may operate by control signals SCAN, CDIS, EM, VTON, INT, and DION of the timing diagram illustrated in FIG. 21 to individually control the VTH compensation and display data updating for each sub frame.

Each of the pixel circuits 410 of the display apparatus 400 has the same or substantially the same structure as that of the pixel circuit of the display apparatus 300. Thus, an updating operation for display data of a display data updating circuit 312 and a VTH compensation operation of a VTH compensation circuit 314 may be individually performed. Therefore, the display apparatus 400 may have the same or substantially the same feature as that of the display apparatus 300.

Also, the 1 vertical period may include two sub frames, and the display apparatus 400 may perform VTH compensation and display data updating for each sub frame. In this case, the display apparatus 400 may control image quality degradation due to leak current of the pixel circuits, which may occur by a difference in timing at which the display data updating is performed after the VTH compensation among the pixel circuits 410.

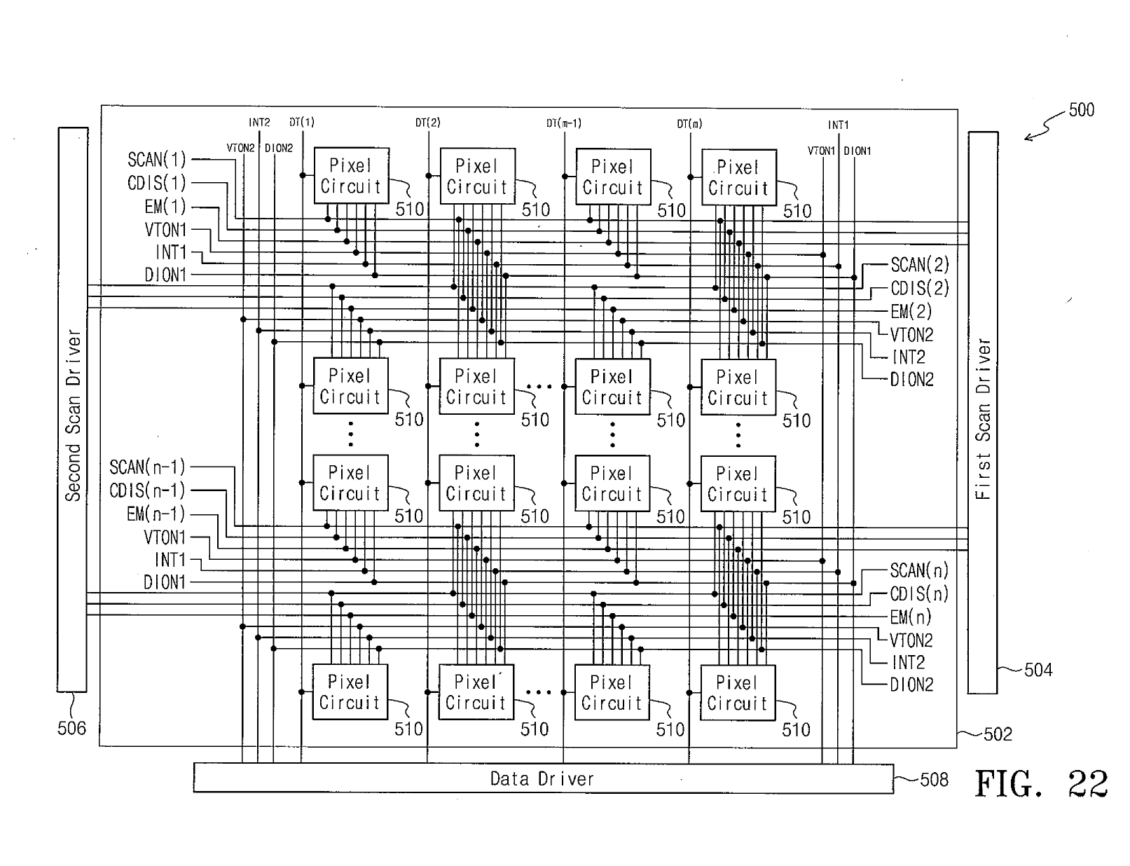

FIG. 22 is a view of a display apparatus according to a fifth embodiment of the inventive concept.

Referring to FIG. 22, a display apparatus 500 includes a display unit 502, a first scan driver 504, a second scan driver 506, and a data driver 508.

When compared to the display apparatus 400 illustrated in FIG. 20, a connection relationship between pixel circuits 510 of the display unit 502 and control lines in the display apparatus 500 is different from those of the display apparatus 400 illustrated in FIG. 20. The control lines are alternately connected to pixel circuits 510 of odd-numbered lines (or rows) and pixel circuits 510 of even-numbered lines (or rows), which are adjacent to each other. Hereinafter, this connection structure is referred to as a dot checkerboard shape.

In the pixel circuits 510 of the odd-numbered rows and even-numbered rows, which are adjacent to each other, odd-numbered pixel circuits 510 of the pixel circuits 510 of the odd-numbered rows and even-numbered pixel circuits 510 of the pixel circuits 510 of the even-numbered rows receive control signals for controlling the display data updating, the threshold voltage compensation of the driving transistor M1, and the light emission of the light emitting device D from the first scan driver 504 and the data driver 508. The first scan driver 504 and the data driver 508 may be referred to as a first driver corresponding to the first sub frame.

Also, in the pixel circuits 510 of the odd-numbered rows and even-numbered rows, which are adjacent to each other, even-numbered pixel circuits 510 of the pixel circuits 510 of the odd-numbered rows and odd-numbered pixel circuits 510 of the pixel circuits 510 of the even-numbered rows receive control signals for controlling the display data updating, the threshold voltage compensation of the driving transistor M1, and the light emission of the light emitting device D from the second scan driver 506 and the data driver 508. The second scan driver 506 and the data driver 508 may be referred to as a second driver corresponding to the second sub frame.

Each of the pixel circuits 510 of the display apparatus 500 has the same or substantially the same structure as that of the pixel circuit of the display apparatus 300. Thus, an updating operation for display data of a display data updating circuit 312 and a VTH compensation operation of a VTH compensation circuit 314 may be individually performed. Therefore, the display apparatus 500 may have the same or substantially the same feature as that of the display apparatus 300.

Also, in the display apparatus 500, the control signals are supplied to the pixel circuits 510 through the control lines connected to the pixel circuits 510 in the dot checkerboard shape. In this case, the display apparatus 500 may further control image quality degradation due to leak current of the pixel circuits 510, which may occur by a difference in timing at which the display data updating is performed after the VTH compensation among the pixel circuits 510.

Although the display apparatus is exemplified according to the various embodiments, the inventive concept is not limited to the foregoing embodiments. For example, the display apparatus according to the example embodiments of the inventive concept may be applicable to various devices, such as a television receiver, a tablet-type device, a communication device, such as a mobile phone or smart phone, an image/music reproducing device (or image/music recording and reproducing device), a game console, and a computer, such as a personal computer.

In the display apparatus, the pixel circuit, and the control method of the display apparatus according to one or more example embodiments of the inventive concept, the threshold voltage compensation (VTH compensation) performance may be improved.

It will be apparent to those skilled in the art that various modifications may be made to the various embodiments of the inventive concept. Thus, it is intended that the present disclosure covers the various modifications of this invention within the spirit and scope of the appended claims, and their equivalents. Thus, to the maximum extent allowed by law, the spirit and scope of the present invention is to be determined by the broadest permissible interpretation of the following claims and their equivalents, and shall not be restricted or limited by the foregoing detailed description.

What is claimed is:

1. A display apparatus comprising:
a display unit configured to receive display data to display an image, the display unit comprising a plurality of pixel circuits arranged in a matrix form,
wherein each of the pixel circuits comprises:
a light emitting device configured to receive current to emit light;
a driving transistor configured to control the current flowing through the light emitting device;
a display data updating circuit comprising a display data capacitor configured to maintain the display data, the display data updating circuit being configured to update the display data that is maintained by the display data capacitor;
a threshold voltage compensation circuit comprising a threshold voltage capacitor configured to maintain a threshold voltage of the driving transistor, the threshold voltage compensation circuit being configured to detect the threshold voltage of the driving transistor and to compensate the threshold voltage; and
a first switch transistor connected to the display data capacitor and the threshold voltage capacitor,
wherein the display data capacitor and the threshold voltage capacitor are configured to be electrically disconnected from each other, when the updating of the display data and the compensation of the threshold voltage of the driving transistor are performed, and
wherein the display data capacitor and the threshold voltage capacitor are configured to be electrically connected to each other, when the light emitting device emits light.

2. The display apparatus of claim 1, wherein the display data updating circuit is configured to update the display data when the threshold voltage is maintained in the threshold voltage capacitor.

3. The display apparatus of claim 2, wherein the threshold voltage compensation circuit is configured to compensate the threshold voltage of the driving transistor when the display data is maintained in the display data capacitor.

4. The display apparatus of claim 3, wherein the display data updating circuit further comprises a second switch transistor configured to control updating timing of the display data, and
wherein the second switch transistor is configured to connect a first electrode of the display data capacitor to a data line to which the display data is supplied according to a control signal to update the display data.

5. The display apparatus of claim 4, wherein the threshold voltage compensation circuit further comprises:
a diode-connecting transistor connected to a first electrode of the threshold voltage capacitor and configured to diode-connect the driving transistor to detect the threshold voltage of the driving transistor;
an initialization transistor configured to initialize a voltage that is maintained in the threshold voltage capacitor; and
a third switch transistor configured to connect a second electrode of the threshold voltage capacitor to a first electrode of the driving transistor when the detection of the threshold voltage of the driving transistor is performed, the first electrode of the driving transistor being opposite to a second electrode of the driving transistor that is connected to the light emitting device,
wherein the threshold voltage of the driving transistor is detected and compensated according to a control signal for detecting and compensating the threshold voltage of the driving transistor.

6. The display apparatus of claim 1, wherein the updating of the display data by the display data updating circuit and the compensation of the threshold voltage of the driving transistor by the threshold voltage compensation circuit are to be performed concurrently.

7. The display apparatus of claim 6, wherein the display data updating circuit further comprises a second switch transistor configured to control updating timing of the display data, and
the second switch transistor is configured to connect a first electrode of the display data capacitor to a data line to which the display data is supplied to update the display data according to a same control signal as the control signal supplied to the threshold voltage compensation circuit to detect and compensate the threshold voltage of the driving transistor.

8. The display apparatus of claim 7, wherein the threshold voltage compensation circuit comprises:
a diode-connecting transistor connected to a first electrode of the threshold voltage capacitor and configured to diode-connect the driving transistor to detect the threshold voltage of the driving transistor;
an initialization transistor configured to initialize a voltage that is maintained in the threshold voltage capacitor; and
a third switch transistor configured to connect a second electrode of the threshold voltage capacitor to a first electrode of the driving transistor when the detection of the threshold voltage of the driving transistor is performed, the first electrode of the driving transistor being opposite to a second electrode of the driving transistor that is connected to the light emitting device,
wherein the threshold voltage of the driving transistor is detected and compensated according to a same control signal supplied to the display data updating circuit to perform the updating of the display data.

9. The display apparatus of claim 8, further comprising a controller configured to control the updating of the display data and the compensation of the threshold voltage of the driving transistor.

10. The display apparatus of claim 8, wherein the updating of the display data and the compensation of the threshold voltage of the driving transistor are to be line-successively performed.

11. The display apparatus of claim 10, wherein the compensation of the threshold voltage of the driving transistor is to be performed during a plurality of horizontal periods.

12. The display apparatus of claim 1, wherein:
the display data updating circuit is configured to update the display data when the threshold voltage is maintained in the threshold voltage capacitor,
the threshold voltage compensation circuit is configured to compensate the threshold voltage of the driving transistor when the display data is maintained in the display data capacitor, and
the threshold voltage compensation of the driving transistor is to be performed concurrently for the plurality of pixel circuits, and the updating of the display data is to be line-successively performed for the plurality of pixel circuits.

13. The display apparatus of claim 12, wherein the threshold voltage compensation of the driving transistor by the threshold voltage compensation circuit is to be performed several times during 1 vertical period.

14. The display apparatus of claim 13, wherein control signals for detecting and compensating the threshold voltage of the driving transistor are to be supplied a plurality of times to the threshold voltage compensation circuit, and
the threshold voltage compensation circuit is configured to detect and to compensate the threshold voltage of the driving transistor according to the control signals.

15. The display apparatus of claim 14, wherein control signals for controlling the updating of the display data, the threshold voltage compensation of the driving transistor, and the light emission of the light emitting device are to be supplied to odd-numbered lines of the pixel circuits from a first driver corresponding to a first sub frame, and
control signals for controlling the updating of the display data, the threshold voltage compensation of the driving transistor, and the light emission of the light emitting device are to be supplied to even-numbered lines of the pixel circuits from a second driver corresponding to a second sub frame.

16. The display apparatus of claim 14, wherein control signals for controlling the updating of the display data, the threshold voltage compensation of the driving transistor, and the light emission of the light emitting device are supplied to odd-numbered pixel circuits of odd-numbered rows of the pixel circuits and to even-numbered pixel circuits of even-numbered rows of the pixel circuits from a first driver corresponding to a first sub frame, and
wherein control signals for controlling the updating of the display data, the threshold voltage compensation of the driving transistor, and the light emission of the light emitting device are supplied to even-numbered pixel circuits of the odd-numbered rows and to odd-numbered pixel circuits of the even-numbered rows from a second driver corresponding to a second sub frame.

17. The display apparatus of claim 12, wherein the display data updating circuit further comprises a second switch transistor configured to control updating timing of the display data, and
the second switch transistor is configured to connect a first electrode of the display data capacitor to a data line to which the display data is supplied according to a control signal to update the display data.

18. The display apparatus of claim 17, wherein the threshold voltage compensation circuit further comprises:
a diode-connecting transistor connected to a first electrode of the threshold voltage capacitor and configured to diode-connect the driving transistor to detect the threshold voltage of the driving transistor;
an initialization transistor configured to initialize a voltage that is maintained in the threshold voltage capacitor; and
a third switch transistor configured to connect a second electrode of the threshold voltage capacitor to a first electrode of the driving transistor when the detection of the threshold voltage of the driving transistor is performed, the first electrode of the driving transistor being opposite to a second electrode of the driving transistor that is connected to the light emitting device,
wherein the threshold voltage of the driving transistor is to be detected and compensated according to a control signal for detecting and compensating the threshold voltage of the driving transistor.

19. A pixel circuit comprising:
a light emitting device configured to receive current to emit light;
a driving transistor configured to control the current flowing through the light emitting device;
a display data updating circuit comprising a display data capacitor configured to maintain the display data, the display data updating circuit being configured to update the display data that is maintained by the display data capacitor;
a threshold voltage compensation circuit comprising a threshold voltage capacitor configured to maintain a threshold voltage of the driving transistor, the threshold voltage compensation circuit being configured to detect the threshold voltage of the driving transistor and to compensate the threshold voltage; and
a switch transistor connected to the display data capacitor and the threshold voltage capacitor,
wherein the display data capacitor and the threshold voltage capacitor are electrically disconnected from each other, when the updating of the display data and the compensation of the threshold voltage of the driving transistor are performed, and
wherein the display data capacitor and the threshold voltage capacitor are electrically connected to each other, when the light emitting device emits light.

20. A method for controlling a display apparatus,
the display apparatus comprising:
a display unit configured to receive display data to display an image, the display unit comprising a plurality of pixel circuits arranged in a matrix form,
wherein each of the pixel circuits comprises:
a light emitting device configured to receive current to emit light;
a driving transistor configured to control the current flowing through the light emitting device;
a display data updating circuit comprising a display data capacitor configured to maintain the display data, the display data updating circuit being configured to update the display data that is maintained by the display data capacitor;
a threshold voltage compensation circuit comprising a threshold voltage capacitor configured to maintain a threshold voltage of the driving transistor, the threshold voltage compensation circuit being configured to detect the threshold voltage of the driving transistor and to compensate the threshold voltage; and
a first switch transistor connected to the display data capacitor and the threshold voltage capacitor,
the method comprising:
controlling updating of the display data, compensation of the threshold voltage of the driving transistor, and light emission of the light emitting device in each of the pixel circuits,
wherein the controlling comprises:
disconnecting the display data capacitor from the threshold voltage capacitor, when the updating of the display data and the compensation of the threshold voltage of the driving transistor are performed; and
electrically connecting the display data capacitor to the threshold voltage capacitor, when the light emitting device emits light.
